(19) United States
(12) Patent Application Publication
(10) Pub. No.: US 2015/0249571 A1
(43) Pub. Date: Sep. 3, 2015

(54) COUNTERPART TERMINAL MANAGEMENT SYSTEM, COMMUNICATION TERMINAL, COMMUNICATION SYSTEM, COUNTERPART TERMINAL MANAGEMENT METHOD, AND RECORDING MEDIUM STORING COUNTERPART TERMINAL MANAGEMENT PROGRAM

(71) Applicant: Akihiro MIHARA, Tokyo (JP)

(72) Inventor: Akihiro MIHARA, Tokyo (JP)

(21) Appl. No.: 14/625,232

(22) Filed: Feb. 18, 2015

(30) Foreign Application Priority Data
Feb. 28, 2014 (JP) 2014-038687

(51) Int. Cl. H04L 12/24; G06F 3/0482; H04L 29/08; G06F 3/0484

(52) U.S. Cl. CPC H04L 41/0806; H04L 41/22; G06F 3/04842; G06F 3/0482; H04L 67/10; H04L 67/141

(57) ABSTRACT

A counterpart terminal management system receives a request for adding a second communication terminal as a candidate counterpart terminal for a first communication terminal that is participating in a session with the second communication terminal, the request for adding being generated based on information indicating that the second communication terminal is not registered as a candidate counterpart terminal for the first communication terminal, and stores counterpart terminal identification information of the second communication terminal in association with terminal identification information of the first communication terminal in response to the request for adding.

### CROSS-REFERENCE TO RELATED APPLICATIONS

This patent application is based on and claims priority pursuant to 35 U.S.C. §119(a) to Japanese Patent Application No. 2014-038687, filed on Feb. 28, 2014, in the Japan Patent Office, the entire disclosure of which is hereby incorporated by reference herein.

### BACKGROUND

1. Technical Field

The present invention relates to managing a candidate counterpart terminal for a communication terminal.

2. Description of the Related Art

Communication systems that perform a videoconference, communication, or the like via a communication network such as the Internet or a dedicated line have become popular in recent years due to a demand for reducing business trip costs and time, and the like. When communication is started between a plurality of communication terminals in such a communication system, image data and sound data are transmitted/received.

There has also been available a method of managing, by using a candidate list, a candidate counterpart terminal to which a communication start requesting terminal in a videoconference can give a request for starting communication. In this case, before a candidate counterpart terminal is added to a candidate list, a permission for addition is obtained from a terminal serving as a candidate counterpart terminal, thereby preventing a terminal from being included in a candidate list of another terminal without knowing it.

After communication such as a videoconference is performed between communication terminals, new communication is sometimes performed between these communication terminals, which had participated in the videoconference, in order to continue the discussion. In the case where a communication terminal that had participated in a videoconference has a candidate list in which another communication terminal that had participated in the videoconference is not registered as a candidate counterpart terminal, this communication terminal cannot give a request for starting new communication. To this end, conventionally, when this other communication terminal which had participated in the videoconference is to be added as a candidate counterpart terminal, this other communication terminal is asked about information necessary for addition, such as terminal identification information, while the videoconference is being held, and, after the videoconference ends, a request for addition is made using the information necessary for addition.

### SUMMARY

Example embodiments of the present invention include a counterpart terminal management system, which stores, for each one of a plurality of communication terminals capable of requesting to start communication with one or more candidate counterpart terminals, terminal identification information for identifying the communication terminal in association with counterpart terminal identification information for identifying the one or more candidate counterpart terminals; transmits, to a first communication terminal that is participating in a session with at least a second communication terminal, information indicating that the second communication terminal is not registered as a candidate counterpart terminal for the first communication terminal; receives a request for adding the second communication terminal as a candidate counterpart terminal for the first communication terminal from the first communication terminal, the request for adding being generated based on the information indicating that the second communication terminal is not registered as a candidate counterpart terminal for the first communication terminal; and stores counterpart terminal identification information of the second communication terminal in association with terminal identification information of the first communication terminal in response to the request for adding.

Example embodiments of the present invention include a communication terminal that is participating in a session with at least a counterpart communication terminal, which receives information indicating that the counterpart communication terminal is not registered as a candidate counterpart terminal for the communication terminal, from a counterpart terminal management system; displays a user interface component that allows a user to send a request for adding the counterpart communication terminal as a candidate counterpart terminal for the communication terminal; and transmits the request for adding the counterpart communication terminal as a candidate counterpart terminal for the communication terminal, to the counterpart terminal management system, in response to selection of the user interface component by the user.

Example embodiments of the present invention include a communication system including the above-described communication terminal and the counterpart terminal management system, a method performed by the communication terminal, a method performed by the counterpart terminal management system, a non-transitory recording medium storing a control program for the communication terminal or a control program for the counterpart terminal management system.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration diagram of a communication system according to an embodiment of the present invention;

FIG. 2 is an illustration of transmission/reception of image data, sound data, and various types of management information in the communication system of FIG. 1;

FIG. 3 is an external view of a communication terminal in the communication system of FIG. 1;

FIG. 4 is a hardware configuration diagram of the communication terminal of FIG. 3;

FIG. 5 is a hardware configuration diagram of a communication management system, a relay device, or a program providing system in the communication system of FIG. 1;

FIG. 6 is a functional block diagram of the communication terminal and the communication management system of FIG. 1;

FIG. 7 is an illustration of a terminal authentication management table;

FIG. 8 is an illustration of a terminal management table;

FIG. 9 is an illustration of a candidate list management table;

FIG. 10 is an illustration of an addition request management table;

FIG. 11 is an illustration of transmission/reception of various types of information in the communication system;

FIGS. 12A and 12B (FIG. 12) are a sequence diagram illustrating operation of preparing for starting communication between terminals;

FIG. 13 is an illustration of a candidate list;

FIG. 14 is a sequence diagram illustrating a conference participation operation until a terminal enters a participation state of participating in a videoconference;

FIG. 15 is an illustration of an example of a display screen in an all-image display mode;

FIG. 16 is an illustration of an example of a display screen in an information display mode;

FIG. 17 is a sequence diagram illustrating a terminal information display operation of a communication system according to a first embodiment;

FIG. 18 is a flowchart illustrating operation of generating a display screen;

FIG. 19 is a sequence diagram illustrating a candidate counterpart terminal adding process;

FIG. 20 is a sequence diagram illustrating operation of displaying terminal information of a communication system according to a second embodiment;

FIG. 21 is a flowchart illustrating operation of generating a display screen; and

FIG. 22 is an illustration of an example of a display screen in the information display mode.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, a first embodiment of the present invention will be described with reference to the drawings.

### <Overall Configuration of Communication System>

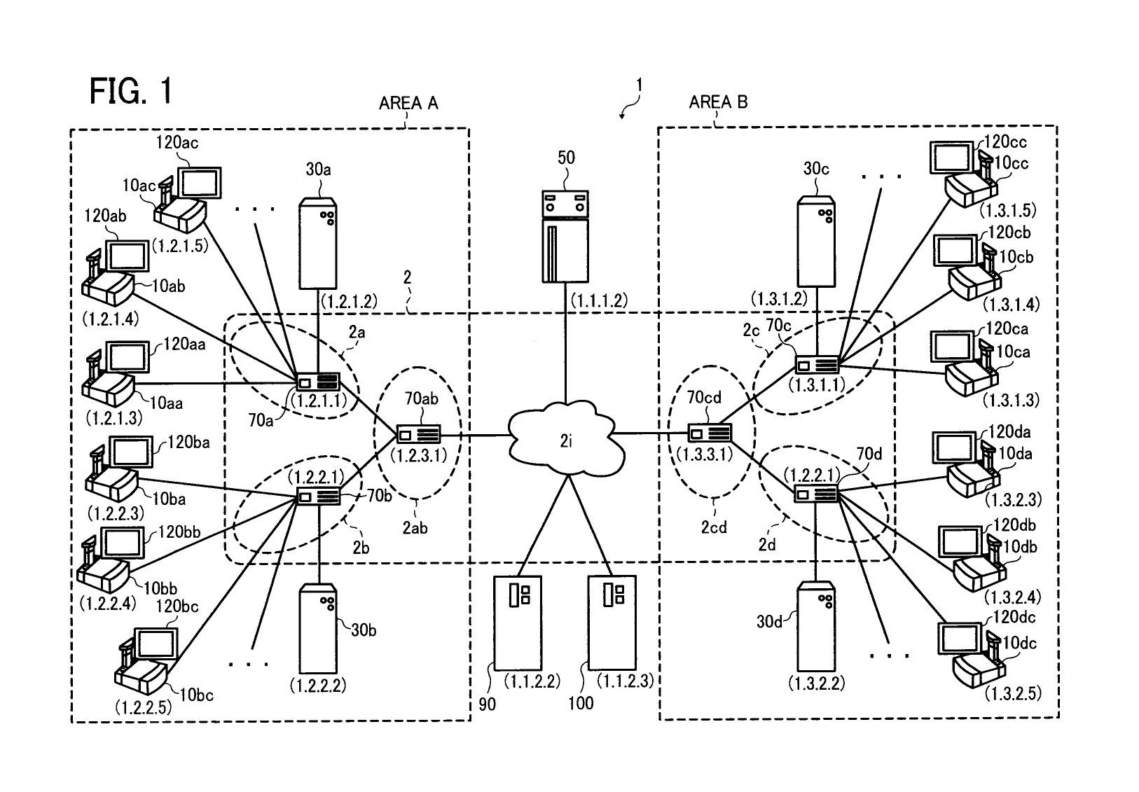

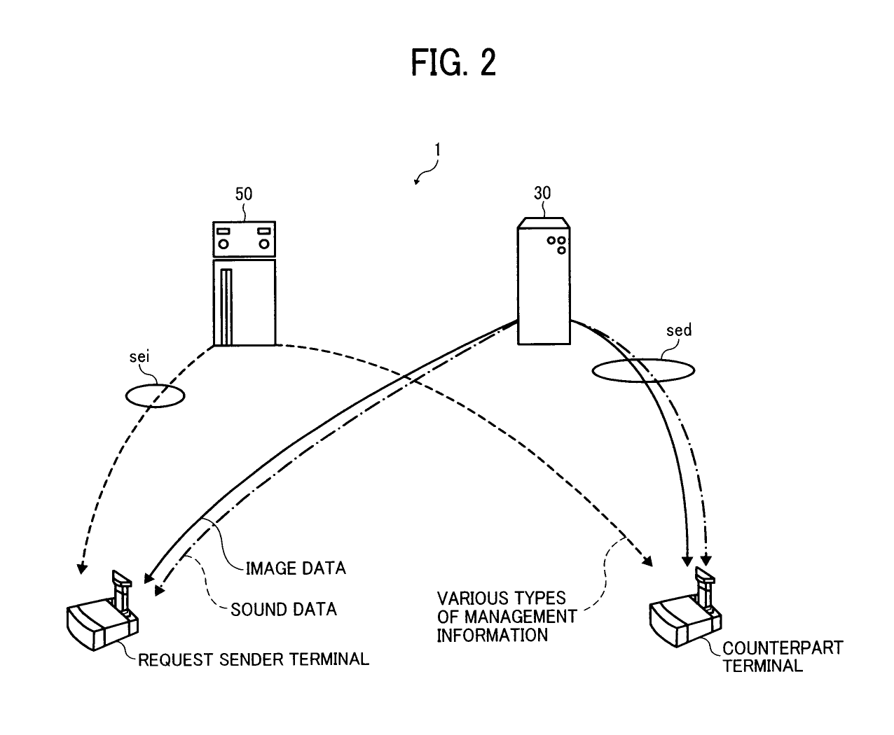

FIG. 1 is a schematic configuration diagram of a communication system according to a first embodiment of the present invention. FIG. 2 is an illustration of transmission/reception of image data, sound data, and various types of management information in the communication system of FIG. 1.

The communication system 1 includes a communication system that intercommunicates information, information that reflects feelings, or the like between a plurality of communication terminals 10 via a communication management system 50. Examples of the communication system include a videoconference system and a teleconference system.

In the embodiment, the communication system, the communication management system, and the communication terminal will be described while assuming a videoconference system serving as an example of the communication system, a videoconference management system serving as the communication management system, and a videoconference terminal serving as an example of the communication terminal. That is, the communication terminal and the communication management system according to the embodiment of the present invention are applied not only to a videoconference system, but also to another communication system. Although the example in the embodiment is described as a “videoconference”, this may alternatively be referred to as a “teleconference”.

Also in the embodiment, the case in which users in the communication system 1 include four offices, namely, a Tokyo office, an Osaka office, a New York office, and a Washington D.C. office, will be described.

The communication system illustrated in FIG. 1 includes a plurality of communication terminals (10aa, 10ab, . . . ), displays (120aa, 120ab, . . . ) for the individual communication terminals (10aa, 10ab, . . . ), a plurality of relay devices (30a, 30b, 30c, and 30d), the communication management system 50, a program providing system 90, and a maintenance system 100.

The plurality of communication terminals 10 perform communication by transmitting and receiving image data and sound data serving as examples of content data.

Hereinafter, the “communication terminal” is simply represented as the “terminal”. In addition, an arbitrary one or ones of the plurality of terminals (10aa, 10ab, . . . ) is/are represented as a “terminal(s) 10”. An arbitrary one or ones of the plurality of displays (120aa, 120ab, . . . ) is/are represented as a “display(s) 120”. An arbitrary one or ones of the plurality of relay devices (30a, 30b, 30c, and 30d) is/are represented as a “relay device(s) 30”. Further, a terminal serving as a request sender that gives a request to start a videoconference is represented as a “request sender terminal”, and a terminal serving as a counterpart terminal that is a request destination (relay destination) is represented as a “counterpart terminal”. Hereinafter, the “communication management system” may simply be represented as the “management system”.

In addition, as illustrated in FIG. 2, a management information session sei for transmitting and receiving various types of management information is established via the management system 50 between a request sender terminal and a counterpart terminal in the communication system 1. A session for transmitting and receiving each of image data and sound data via a corresponding one of the relay devices 30 is also established between the request sender terminal and the counterpart terminal. Here, these sessions are collectively indicated as a content data session sed.

The relay devices 30 illustrated in FIG. 1 relay content data between the plurality of terminals 10. The management system 50 collectively manages login authentication from the terminals 10, the communication states, candidate lists, and so forth of the terminals 10, and the communication states and so forth of the relay devices 30. Note that an image of image data may be a moving image or a still image, or may include both thereof.

A plurality of routers (70a, 70b, 70c, 70d, 70ab, and 70cd) select an optimal path for image data and sound data. Hereinafter, an arbitrary one or ones of the routers (70a, 70b, 70c, 70d, 70ab, and 70cd) is/are represented as a “router(s) 70”.

The program providing system 90 includes a hard disk (HD) 204 described later. The HD 204 stores a terminal program for causing a terminal 10 to realize various functions (or for causing a terminal 10 to function as various elements), and the terminal program can be transmitted to the terminal 10. In addition, the HD 204 of the program providing system 90 stores a relay device program for causing a relay device 30 to realize various functions (or for causing a relay device 30 to function as various elements), and the relay device program can be transmitted to the relay device 30. Further, the HD 204 of the program providing system 90 stores a communication management program for causing the management system 50 to realize various functions (or for causing the management system 50 to function as various elements), and the communication management program can be transmitted to the management system 50.

The maintenance system 100 is one or more computers for performing maintenance, management, or conservation of at least one of the terminals 10, the relay devices 30, the management system 50, and the program providing system 90. For example, in the case where the maintenance system 100 is located in one country, and the terminals 10, the relay devices 30, the management system 50, or the program providing system 90 is/are located outside that country, the maintenance system 100 remotely performs, via a communication network 2, maintenance, management, or conservation of at least one of the terminals 10, the relay devices 30, the management system 50, and the program providing system 90. In addition, the maintenance system 100 performs maintenance such as management of the modal number, serial number, sales contact, maintenance checkup, or a past history of failures of at least one of the terminals 10, the relay devices 30, the management system 50, and the program providing system 90 without having the communication network 2 therebetween.

The terminals (10aa, 10ab, 10ac, . . . ), the relay device 30a, and the router 70a are connected to be communicable with each other by a local area network (LAN) 2a. The terminals (10ba, 10bb, 10bc, . . . ), the relay device 30b, and the router 70b are connected to be communicable with each other by a LAN 2b. In addition, the LAN 2a and the LAN 2b are connected to be communicable with each other by a dedicated line 2ab including the router 70ab and are configured in a certain area A. For example, the area A is Japan, the LAN 2a is configured in the office in Tokyo, and the LAN 2b is configured in the office in Osaka.

The terminals (10ca, 10cb, 10cc, . . . ), the relay device 30c, and the router 70c are connected to be communicable with each other by a LAN 2c. The terminals (10da, 10db, 10dc, . . . ), the relay device 30d, and the router 70d are connected to be communicable with each other by a LAN 2d. In addition, the LAN 2c and the LAN 2d are connected to be communicable with each other by a dedicated line 2cd including the router 70cd and are configured in a certain area B. For example, the area B is the United States, the LAN 2c is configured in the office in New York, and the LAN 2d is configured in the office in Washington D.C. The area A and the area B are connected to be communicable with each other from the routers (70ab and 70cd), respectively, via the Internet 2i.

In addition, the management system 50 and the program providing system 90 are connected to be communicable with the terminals 10 and the relay devices 30 via the Internet 2i. The management system 50 and the program providing system 90 may be located in the area A or the area B, or may be located in other areas.

In the embodiment, the communication network 2 of the embodiment includes the LAN 2a, the LAN 2b, the dedicated line tab, the Internet 2i, the dedicated line 2cd, the LAN 2c, and the LAN 2d. The communication network 2 may include not only a wired network, but also a network where communication is performed wirelessly, such as Wireless Fidelity (WiFi) or Bluetooth (registered trademark).

In addition in FIG. 1, four digits indicated below each of the terminals 10, each of the relay devices 30, the management system 50, each of the routers 70, and the program providing system 90 indicates an IP address in an abbreviated form in the general Internet Protocol version 4 (IPv4). For example, the IP address of the terminal 10aa is “1.2.1.3”. Although IPv6 may be used instead of IPv4, IPv4 is used in order to make the description simple.

Note that the terminals 10 may be used not only for communication between different offices or for communication between different rooms in the same office, but also for communication within the same room or for outdoor-indoor communication or outdoor-outdoor communication. In the case where the terminals 10 are used outside, wireless communication using a mobile phone communication network or the like is performed.

### <Hardware Configuration of Communication System>

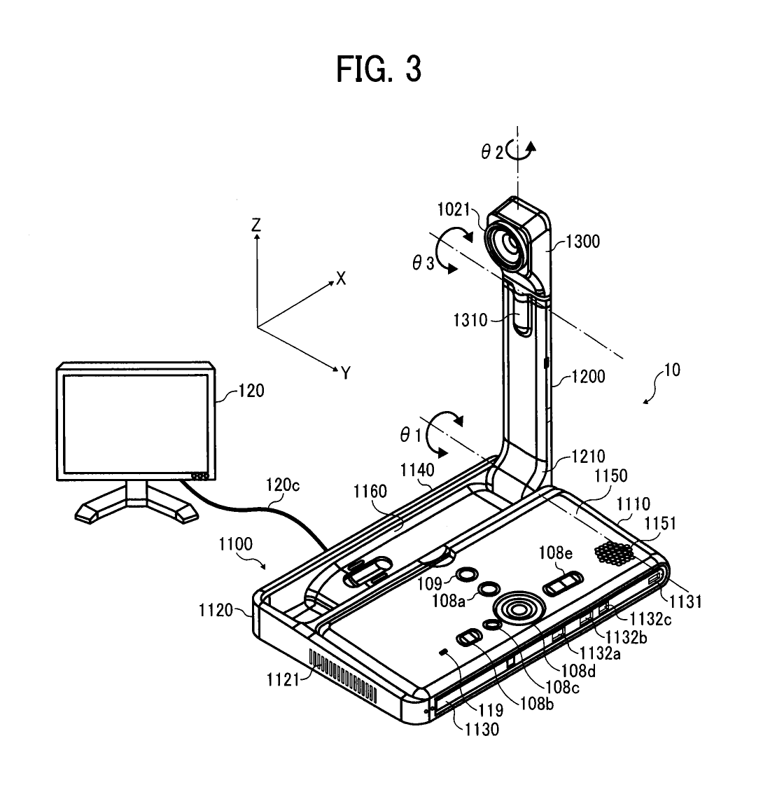

Next, the hardware configuration of the communication system 1 will be described. FIG. 3 is an external view of a terminal 10 according to the embodiment. The description will be given assuming that the longitudinal direction of the terminal 10 is the X-axis direction, a direction orthogonal to the X-axis direction on one plane is the Y-axis direction, and a direction orthogonal to the X-axis direction and the Y-axis direction (vertical direction) is the Z-axis direction.

As illustrated in FIG. 3, the terminal 10 includes a casing 1100, an arm 1200, and a camera housing 1300. Among these portions, a front wall 1110 of the casing 1100 has an inlet face including a plurality of inlet holes, and a back wall 1120 of the casing 1100 has an exhaust face 1121 on which a plurality of exhaust holes are formed. Accordingly, by driving of a cooling fan included in the casing 1100, air behind the terminal 10 can be taken in via the inlet face and exhausted to the rear of the terminal 10 via the exhaust face 1121. A right-side wall 1130 of the casing 1100 has a sound pickup hole 1131 formed thereon, and a built-in microphone 114, described later, is capable of picking up sound and noise.

An operation panel 1150 is formed toward the right-side wall 1130 of the casing 1100. The operation panel 1150 has a plurality of operation keys (108a to 108e) described later, a power switch 109 described later, and an alarm lamp 119 described later, which are formed thereon. The operation panel 1150 also has a sound output face 1151 formed thereon, which is formed of a plurality of sound output holes for allowing output sound from a built-in speaker 115, described later, to pass through. In addition, an accommodation portion 1160 serving as a recess for accommodating the arm 1200 and the camera housing 1300 is formed toward a left-side wall 1140 of the casing 1100. A plurality of connection ports (1132a to 1132c) for electrically connecting cables to an external device connection interface (I/F) 118 described later are provided on the right-side wall 1130 of the casing 1100. In contrast, a connection port for electrically connecting a cable 120c for a display 120 to the external device connection I/F 118 described later is provided toward the left-side wall 1140 of the casing 1100.

The following description uses the term “operation key(s) 108” for indicating an arbitrary one or ones of the operation keys (108a to 108e), and the term “connection port(s) 1132” for indicating an arbitrary one or ones of the connection ports (1132a to 1132c). Next, the arm 1200 is attached to the casing 1100 via a torque hinge 1210 and is configured to be rotatable in the vertical direction within a range of a tilt angle θ1 of 135 degrees with respect to the casing 1100. FIG. 3 indicates a state in which the tilt angle θ1 is 90 degrees.

The camera housing 1300 has a built-in camera 112 provided thereon, which will be described later, and the camera 112 can capture an image of a user, a document, a room, or the like. In addition, the camera housing 1300 has a torque hinge 1310 formed thereon. The camera housing 1300 is attached to the arm 1200 via the torque hinge 1310 and is configured to be rotatable in the vertical and horizontal directions within a range of a pan angle θ2 of ±180 degrees and a tilt angle θ3 of ±45 degrees with respect to the state illustrated in FIG. 3 serving as 0 degrees.

Since the relay devices 30, the management system 50, the program providing system 90, and the maintenance system 100 each have the same appearance as that of a general server computer, descriptions of the appearances thereof are omitted.

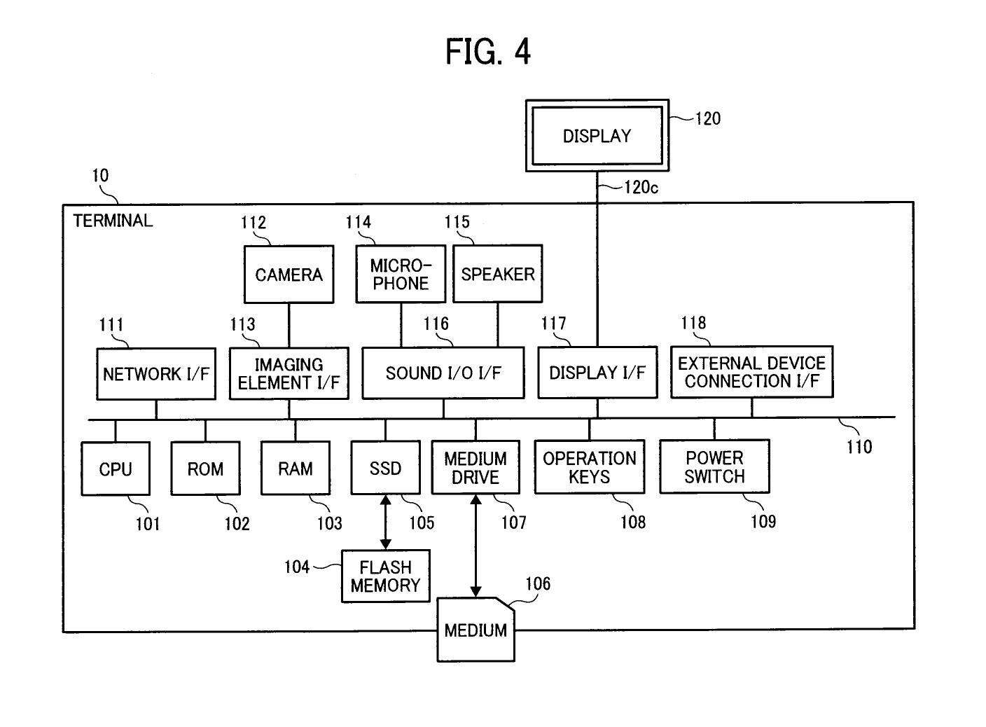

FIG. 4 is a hardware configuration diagram of a terminal 10 according to the embodiment of the present invention. As illustrated in FIG. 4, the terminal 10 of the embodiment includes a central processing unit (CPU) 101 that controls the overall operation of the terminal 10, a read-only memory (ROM) 102 that stores a program used for driving the CPU 101, such as an initial program loader (IPL), a random-access memory (RAM) 103 used as a work area for the CPU 101, a flash memory 104 that stores various types of data, such as the terminal program, image data, and sound data, a solid state drive (SSD) 105 that controls reading/writing of various types of data from/to the flash memory 104 under control of the CPU 101, a medium drive 107 that controls reading/writing (storage) of data from/to a recording medium 106 such as a flash memory, the operation keys 108 operated in the case of, for example, selecting a counterpart terminal of the terminal 10, the power switch 109 for turning on/off the power of the terminal 10, and a network interface (I/F) 111 for performing data communication using the communication network 2.

In addition, the terminal 10 includes the built-in camera 112, which captures an image of a subject and obtains image data under control of the CPU 101, an imaging element I/F 113 that controls driving of the camera 112, the built-in microphone 114, which receives a sound input, the built-in speaker 115, which outputs sound, a sound input/output I/F 116 that processes inputting/outputting of a sound signal between the microphone 114 and the speaker 115 under control of the CPU 101, a display I/F 117 that transmits image data to an external display 120 under control of the CPU 101, the external device connection I/F 118 connected to a connection port 1021g illustrated in FIG. 3 in order to connect various external devices, and a bus line 110 such as an address bus and a data bus for electrically connecting the above-described elements as illustrated in FIG. 4.

Each of the displays 120 displays an image of a subject, an icon for operation, or the like, and is a liquid crystal display (LCD) or an organic electroluminescence (EL) display. In addition, the display 120 is connected to the display I/F 117 by the cable 120c. The cable 120c may be an analog red green blue (RGB) (video graphic array (VGA)) signal cable, a component video cable, a high-definition multimedia interface (HDMI) signal cable, or a digital video interactive (DVI) signal cable.

The camera 112 includes a lens and a solid-state imaging element that converts an image (video) of a subject to electronic data by converting light to electric charge. As the solid-state imaging element, for example, a complementary metal-oxide-semiconductor (CMOS) or a charge-coupled device (CCD) is used.

The external device connection I/F 118 is capable of connecting an external device such as an external camera, an external microphone, or an external speaker by using a Universal Serial Bus (USB) cable or the like. In the case where an external camera is connected, the external camera is driven in preference to the built-in camera 112 under control of the CPU 101. Similarly, in the case where an external microphone is connected or an external speaker is connected, the external microphone or the external speaker is driven in preference to the built-in microphone 114 or the built-in speaker 115 under control of the CPU 101.

Note that the recording medium 106 is configured to be removable from the terminal 10. In addition, a non-volatile memory that reads or writes data under control of the CPU 101 is not limited to the flash memory 104, and an electrically erasable and programmable read-only memory (EEPROM) may be used instead.

Further, the terminal program may be recorded in a file in an installable format or an executable format on a computer-readable recording medium such as the recording medium 106 and distributed. In addition, the terminal program may be stored on the ROM 102, instead of the flash memory 104.

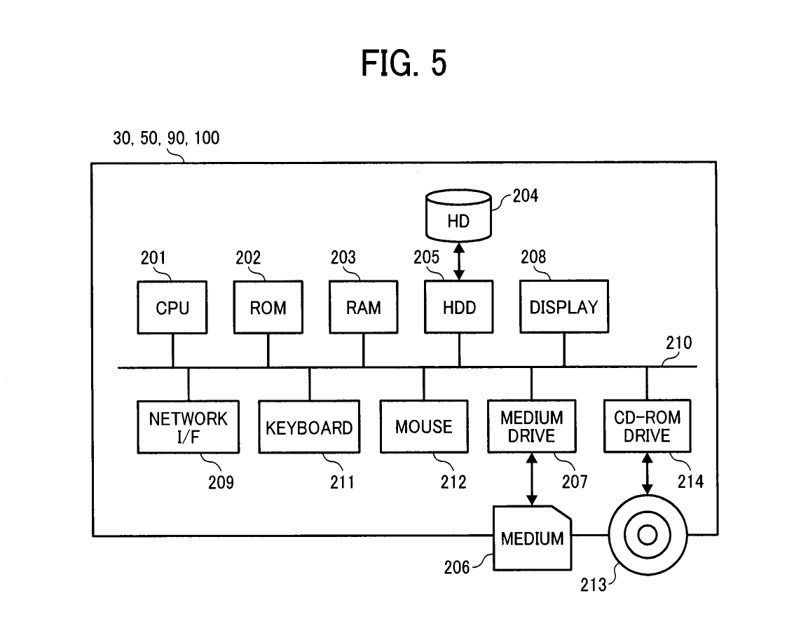

FIG. 5 is a hardware configuration diagram of the management system according to the embodiment of the present invention. The management system 50 includes a CPU 201 that controls the overall operation of the management system 50, a ROM 202 that stores a program used for driving the CPU 201, such as an IPL, a RAM 203 used as a work area for the CPU 201, an HD 204 that stores various types of data, such as the communication management program, a hard disk drive (HDD) 205 that controls reading/writing of various types of data from/to the HD 204 under control of the CPU 201, a medium drive 207 that controls reading/writing (storage) of data from/to a recording medium 206 such as a flash memory, a display 208 that displays various types of information such as a cursor, a menu, a window, characters, or an image, a network I/F 209 for communicating data using the communication network 2, a keyboard 211 including a plurality of keys for entering characters, numerals, and various instructions, a mouse 212 that selects and executes various instructions, selects a processing target, and moves the cursor, a compact disc read-only memory (CD-ROM) drive 214 that controls reading/writing of various types of data from/to a CD-ROM 213 serving as an example of a removable recording medium, and a bus line 210 such as an address bus and a data bus for electrically connecting the above-described elements as illustrated in FIG. 5.

Note that the communication management program may be recorded in a file in an installable format or an executable format on a computer-readable recording medium such as the recording medium 206 or the CD-ROM 213 and distributed. In addition, the communication management program may be stored on the ROM 202, instead of the HD 204.

In addition, since the relay devices 30 have a hardware configuration that is the same as or similar to that of the above-described management system 50, a description thereof is omitted. Note that the HD 204 stores a relay device program for controlling the relay devices 30. Also in this case, the relay device program may be recorded in a file in an installable format or an executable format on a computer-readable recording medium such as the recording medium 206 or the CD-ROM 213 and distributed. In addition, the relay device program may be stored on the ROM 202, instead of the HD 204.

In addition, since the program providing system 90 and the maintenance system 100 each have a hardware configuration that is the same as or similar to that of the above-described management system 50, descriptions thereof are omitted. Note that the HD 204 stores a program providing program for controlling the program providing system 90. Also in this case, the program providing program may be recorded in a file in an installable format or an executable format on a computer-readable recording medium such as the recording medium 206 or the CD-ROM 213 and distributed. In addition, the program providing program may be stored on the ROM 202, instead of the HD 204.

Note that each of the above-described programs may be recorded on a computer-readable recording medium such as a compact disc recordable (CD-R), a digital versatile disk (DVD), or a Blu-ray disk, which serve as other examples of the above-described removable recording medium, and may be provided.

### <Functional Configuration of Communication System>

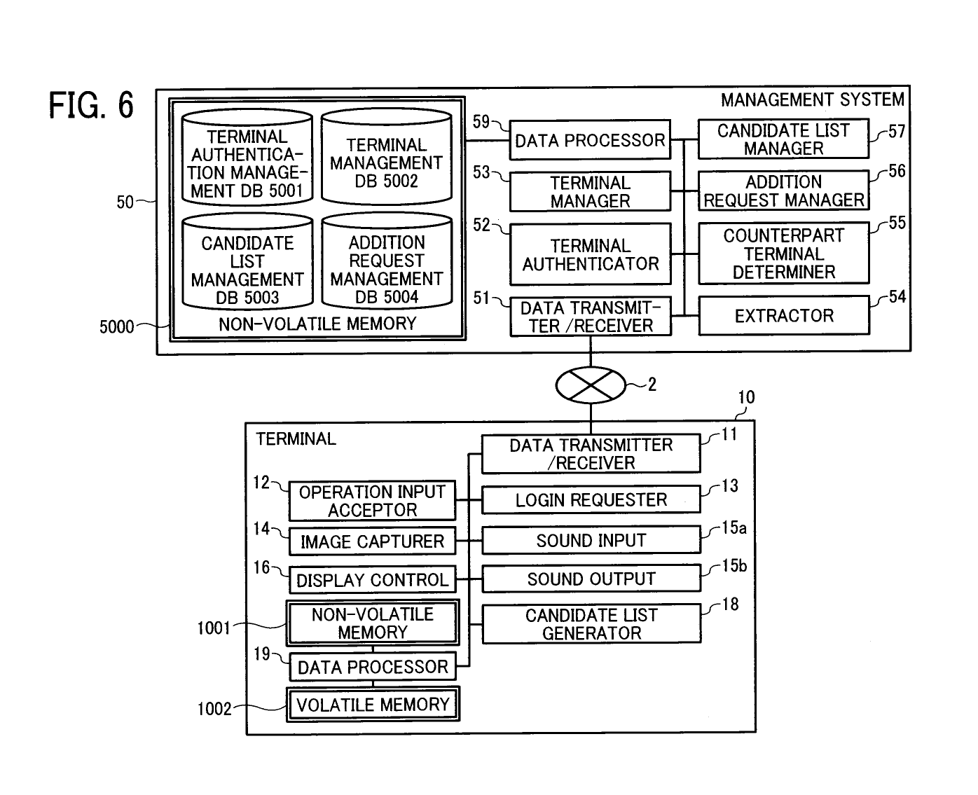

Next, the functional configuration of the embodiment will be described. FIG. 6 is a functional block diagram of the terminal and the management system included in the communication system 1 of the embodiment. In FIG. 6, the terminal 10 and the management system 50 are connected to be capable of communicating data via the communication network 2. In addition, since the program providing system 90 illustrated in FIG. 1 is not directly related to videoconference communication, the program providing system 90 is omitted in FIG. 6.

### <Functional Configuration of Terminal>

The terminal 10 includes a data transmitter/receiver 11, an operation input acceptor 12, a login requester 13, an image capturer 14, a sound input 15a, a sound output 15b, a display control 16, a candidate list generator 18, and a data processor 19. These elements are functions that are realized by or elements that are caused to function by operating any of the elements illustrated in FIG. 4 in response to a command from the CPU 101 in accordance with a terminal program expanded from the flash memory 104 to the RAM 103.

In addition, the terminal 10 includes a volatile memory 1002 including the RAM 103 illustrated in FIG. 4, and a non-volatile memory 1001 including the flash memory 104 illustrated in FIG. 4.

Next, using FIGS. 4 and 6, functional configuration of the terminal 10 will be described. Note that, in the following description of functional configuration of the terminal 10, among elements illustrated in FIG. 4, relationships with main elements for realizing the functional configuration of the terminal 10 will also be described.

The data transmitter/receiver 11 of the terminal 10 illustrated in FIG. 6 is realized by a command from the CPU 101 illustrated in FIG. 4 and by the network I/F 111 illustrated in FIG. 4, and performs transmission/reception of various types of data (or information) to/from another terminal, apparatus, or system via the communication network 2. Before starting communication with a desired counterpart terminal, the data transmitter/receiver 11 starts receiving, from the management system 50, operation state information indicating the operation state of each terminal serving as a candidate counterpart terminal. The operation state information not only indicates the operation state of each terminal 10 (whether the terminal 10 is online or offline), but also indicates a detailed state such as whether the terminal 10 whose state is online is now communicating or the user of the terminal 10 is not at the terminal 10. In addition, the operation state information not only indicates the operation state of each terminal 10, but also indicates various states, such as the state that the cable 120c is disconnected from the terminal 10, the state that the terminal 10 can output sound but not images, or the state that the terminal 10 is muted.

The operation input acceptor 12 is realized by a command from the CPU 101 illustrated in FIG. 4 and by the operation keys 108 and the power switch 109 illustrated in FIG. 4, and accepts various inputs from the user. For example, when the user turns on the power switch 109 illustrated in FIG. 4, the operation input acceptor 12 illustrated in FIG. 6 accepts the power on operation and turns on the power.

The login requester 13 is realized by a command from the CPU 101 illustrated in FIG. 4, and, upon acceptance of the above-described power on operation, automatically transmits, from the data transmitter/receiver 11 to the management system 50 via the communication network 2, login request information indicating a login request, and the current IP address of the request sender terminal. In addition, when the user turns the power switch 109 from on to off, the data transmitter/receiver 11 transmits to the management system 50 state information indicating that the power is to be turned off, and then the operation input acceptor 12 completely turns off the power. Accordingly, the management system 50 side can detect that the power of the terminal 10 is turned from on to off.

The image capturer 14 is realized by a command from the CPU 101 illustrated in FIG. 4 and by the camera 112 and the imaging element I/F 113 illustrated in FIG. 4. The image capturer 14 captures an image of a subject and outputs image data obtained by capturing the image.

The sound input 15a is realized by a command from the CPU 101 illustrated in FIG. 4 and by the sound input/output I/F 116 illustrated in FIG. 4. After the voice of the user is converted to a sound signal by the microphone 114, the sound input 15a receives sound data according to this sound signal. The sound output 15b is realized by a command from the CPU 101 illustrated in FIG. 4 and by the sound input/output I/F 116 illustrated in FIG. 4, and outputs the sound signal according to the sound data to the speaker 115, and the speaker 115 outputs sound.

The display control 16 is realized by a command from the CPU 101 illustrated in FIG. 4 and by the display I/F 117 illustrated in FIG. 4, and performs control for transmitting image data to the external display 120.

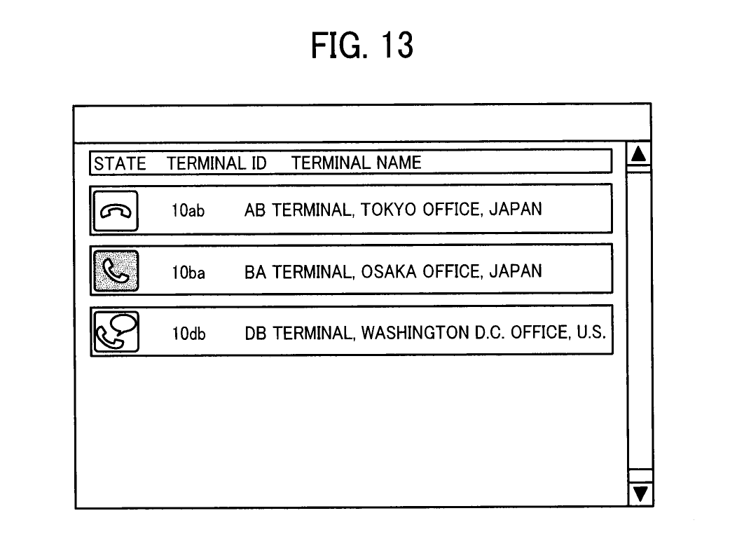

The candidate list generator 18 generates and updates a candidate list in which the state of a candidate counterpart terminal such as that illustrated in FIG. 13 is indicated by an icon, on the basis of later-described candidate list information and the state information of each terminal 10 serving as a candidate counterpart terminal, which are received from the management system 50.

In addition, the data processor 19 is executed by a command from the CPU 101 illustrated in FIG. 4 and by the SSD 105 illustrated in FIG. 4, and performs processing to store various types of data in the non-volatile memory 1001 or to read various types of data stored in the non-volatile memory 1001. The non-volatile memory 1001 stores a terminal identification (ID) serving as an example of identification information for identifying the terminal 10, a password, and the like. Further, the data processor 19 also performs processing to store various types of data in the volatile memory 1002 or to read various types of data stored in the volatile memory 1002. Every time image data and sound data are received in performing communication with a counterpart terminal, the volatile memory 1002 overwrites and stores the image data and sound data. On the basis of image data before being overwritten, an image is displayed on the display 120, and, on the basis of sound data before being overwritten, sound is output from the speaker 115.

Note that a terminal ID and a later-described relay device ID in the embodiment indicate identification information such as a language, a character(s), a symbol(s), or various marks used to uniquely identify a corresponding terminal 10 and a corresponding relay device 30. In addition, a terminal ID and a relay device ID may be identification information including a combination of at least two of the above-mentioned language, character(s), symbol(s), and various marks.

### <Functional Configuration of Management System>

The management system 50 includes a data transmitter/receiver 51, a terminal authenticator 52, a terminal manager 53, an extractor 54, a counterpart terminal determiner 55, an addition request manager 56, a candidate list manager 57, and a data processor 59. These elements are functions that are realized by or elements that are caused to function by operating any of the elements illustrated in FIG. 5 in response to a command from the CPU 201 in accordance with a management system program expanded from the HD 204 to the RAM 203. In addition, the management system 50 includes a non-volatile memory 5000 in which the storage of various types of data (or information) is maintained even when the power of the management system 50 is turned off, and the non-volatile memory 5000 is configured by the HD 204 illustrated in FIG. 5. In addition, the non-volatile memory 5000 stores data of a candidate list frame illustrated in FIG. 13 (which is data of a candidate list frame portion illustrated in FIG. 13, and which includes no icon indicating a specific operation state, no terminal ID, or no terminal name).

### (Terminal Authentication Management Table)

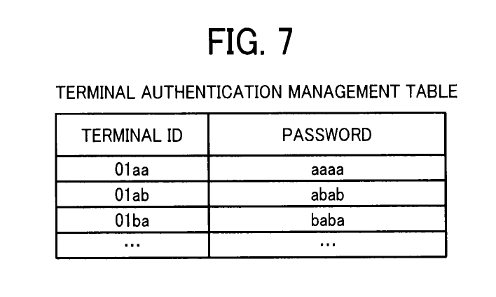

The non-volatile memory 5000 stores a terminal authentication management DB 5001, such as a terminal authentication management table of FIG. 7. In the terminal authentication management table, a password is managed in association with each of terminal IDs of all terminals 10 managed by the management system 50. For example, the terminal authentication management table illustrated in FIG. 7 indicates that the terminal ID of the terminal 10aa is “01aa”, and the password of the terminal 10aa is “aaaa”.

### (Terminal Management Table)

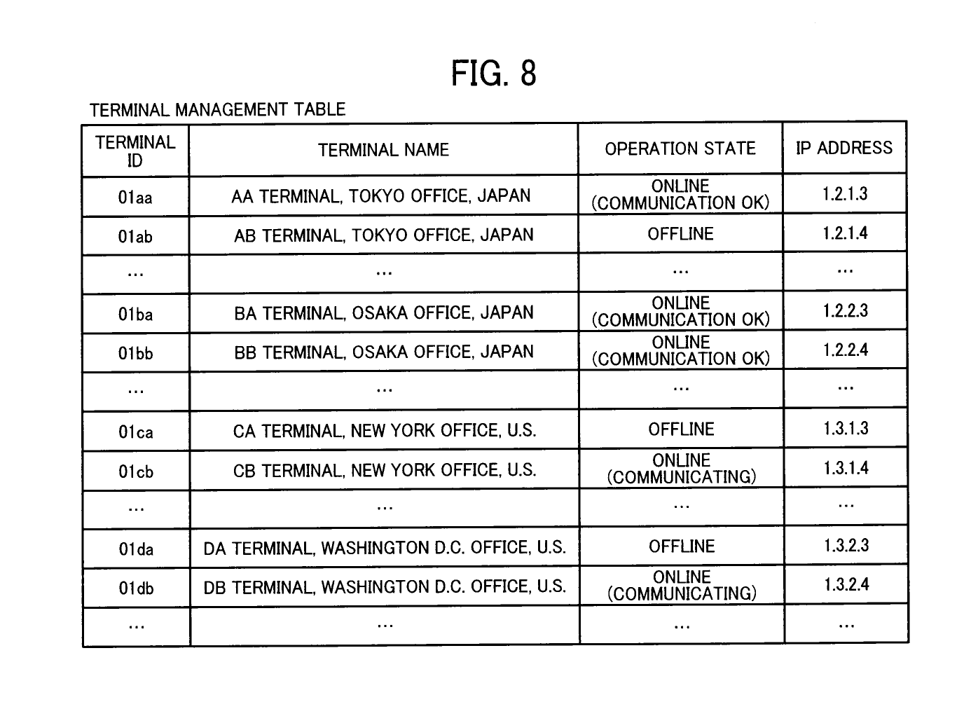

The non-volatile memory 5000 stores a terminal management DB 5002, which may be implemented by a terminal management table such as that illustrated in FIG. 8. In the terminal management table, the counterpart terminal name (terminal name) of each terminal 10 in the case where the terminal 10 serves as a counterpart terminal, the operation state, and the IP address of the terminal 10 are managed in association with the terminal ID of the terminal 10. For example, the terminal management table illustrated in FIG. 8 indicates that the terminal 10aa whose terminal ID is “01aa” has the terminal name “AA terminal, Tokyo office, Japan”, the operation state “online (communication OK)”, and the IP address “1.2.1.3”.

### (Candidate List Management Table)

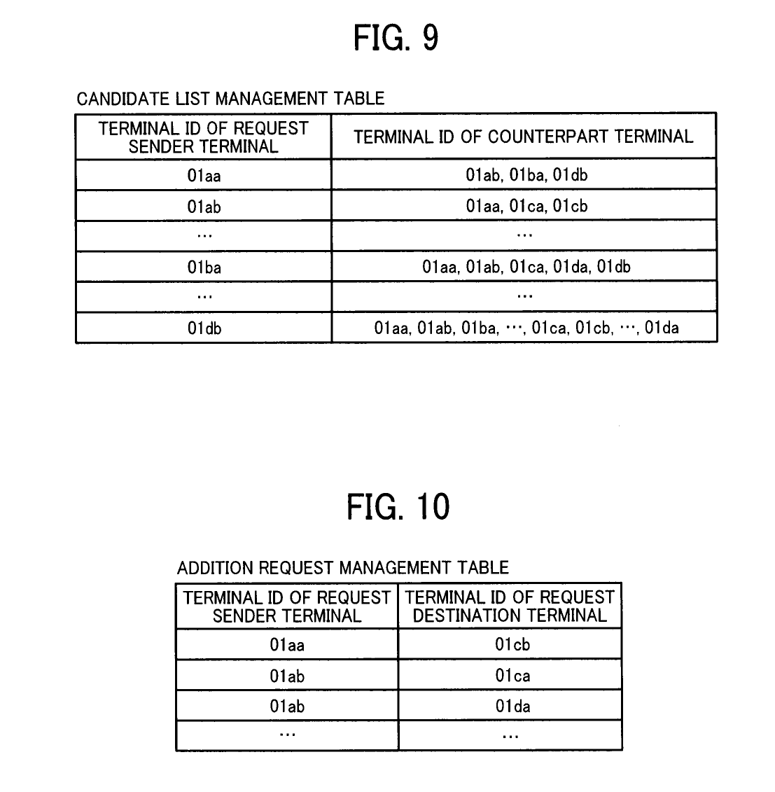

The non-volatile memory 5000 further stores a candidate list management DB 5003 implemented by a candidate list management table such as that illustrated in FIG. 9. In the candidate list management table, in association with the terminal ID of a request sender terminal that gives a request for starting communication in a videoconference, the terminal IDs of all counterpart terminals registered as candidate counterpart terminals to which the request sender terminal can give a request for starting communication are managed. For example, the candidate list management table illustrated in FIG. 9 indicates that counterpart terminals to which a request sender terminal (terminal 10aa) whose terminal ID is “01aa” can give a request for starting communication in a videoconference are the terminal 10ab whose terminal ID is “01ab”, the terminal 10ba whose terminal ID is “01ba”, the terminal 10db whose terminal ID is “01db”, and so forth. The candidate counterpart terminals are updated by addition or deletion in response to an addition or deletion request from an arbitrary request sender terminal to the management system 50. Note that, in the candidate list management DB 5003 (see FIG. 9), not only the terminal ID of a counterpart terminal registered as a candidate for a counterpart terminal, but also a counterpart terminal name managed for each terminal ID in the terminal management table (see FIG. 8) may also be managed in association therewith.

### (Addition Request Management Table)

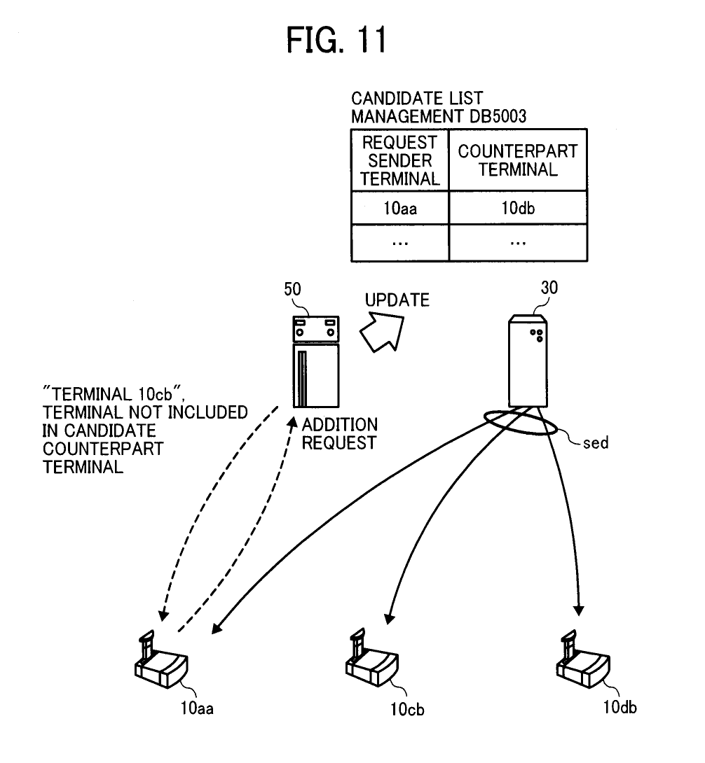

The non-volatile memory 5000 stores an addition request management DB 5004 implemented by an addition request management table such as that illustrated in FIG. 10. In the addition request management table, the terminal ID of a terminal 10 that gives a request for addition as a candidate counterpart terminal, and the terminal ID of a terminal 10 requested to be added as a candidate counterpart terminal are managed in association with each other. Accordingly, which terminal 10 has requested which terminal 10 to be added as a candidate counterpart terminal can be managed. Since the candidate list management table and the addition request management table are common in the terminal ID of a request sender terminal, these tables may be integrated as one table.

### <Functional Configuration of Management System>

Next, functional configuration of the management system 50 will be described in detail. Note that, in the following description of functional configuration of the management system 50, among elements illustrated in FIG. 5, relationships with main elements for realizing the functional configuration of the management system 50 will also be described.

The data transmitter/receiver 51 is executed by a command from the CPU 201 illustrated in FIG. 5 and by the network I/F 209 illustrated in FIG. 5, and performs transmission/reception of various types of data (or information) to/from another terminal, apparatus, or system via the communication network 2.

The terminal authenticator 52 is realized by a command from the CPU 201 illustrated in FIG. 5, and performs terminal authentication by searching the terminal authentication management DB 5001 (see FIG. 7) in the non-volatile memory 5000 by using a terminal ID and a password included in login request information received via the data transmitter/receiver 51 as search keys and determining whether the same pair of a terminal ID and a password is managed in the terminal authentication management DB 5001.

The terminal manager 53 is realized by a command from the CPU 201 illustrated in FIG. 5. In order to manage the operation state of a request sender terminal that has given a login request, the terminal manager 53 stores and manages, in the terminal management DB 5002 (see FIG. 8), the terminal ID, the operation state, and the IP address of this request sender terminal in association with one another. In addition, on the basis of operation state information sent from the terminal 10 indicating that power is to be turned off when the user turns the power switch 109 of the terminal 10 from on to off, the terminal manager 53 changes the operation state indicating an online state to an offline state in the terminal management DB 5002 (see FIG. 8).

The extractor 54 is realized by a command from the CPU 201 illustrated in FIG. 5, searches the candidate list management DB 5003 (see FIG. 9) by using the terminal ID of a request sender terminal that has given a login request as a key, and reads the terminal ID of a candidate counterpart terminal that can communicate with the request sender terminal, thereby extracting the terminal ID. The extractor 54 also searches the candidate list management DB 5003 (see FIG. 9) by using the terminal ID of a request sender terminal that has given a login request as a key, and extracts the terminal ID of another request sender terminal that has the terminal ID of the former-mentioned request sender terminal registered as a candidate for a counterpart terminal. In addition, the extractor 54 searches the terminal management DB 5002 (see FIG. 8) by using the terminal ID of a candidate counterpart terminal, extracted by the extractor 54, as a search key, and reads the operation state for each terminal ID extracted by the extractor 54. Accordingly, the extractor 54 can obtain the operation state of a candidate counterpart terminal that can communicate with a request sender terminal that has given a login request. The extractor 54 also searches the terminal management DB 5002 (see FIG. 8) by using the terminal ID extracted by the extractor 54 as a search key, and extracts the operation state of a request sender terminal that has given a login request.

The counterpart terminal determiner 55 is realized by a command from the CPU 201 illustrated in FIG. 5, and determines whether the terminal ID of a participant terminal that is participating in a content data session sed is included in the terminal ID(s) of a counterpart terminal(s) when another participant terminal serves as a communication start request sender terminal. The addition request manager 56 is realized by a command from the CPU 201 illustrated in FIG. 5, and, for each new record in the addition request management DB 5004 (see FIG. 10), stores and manages the terminal ID of a request sender terminal and the terminal ID of a request destination terminal. In addition, the terminal ID of a request sender terminal and the terminal ID of a request destination terminal are deleted on a record-by-record basis.

The candidate list manager 57 is realized by a command from the CPU 201 illustrated in FIG. 5, and adds or deletes the terminal ID of a counterpart terminal for the terminal ID of each request sender terminal in the candidate list management DB 5003 (see FIG. 9). In addition, the candidate list manager 57 additionally manages, in association with the terminal ID of a request sender terminal in the candidate list management DB 5003 (see FIG. 9) which is the same as the terminal ID of a request sender terminal managed in the addition request management DB 5004 (see FIG. 10), the terminal ID of a request destination terminal managed in association with the terminal ID of a request sender terminal in the addition request management DB 5004 (see FIG. 10) as the terminal ID of a counterpart terminal.

The data processor 59 is executed by a command from the CPU 201 illustrated in FIG. 5 and the HDD 205 illustrated in FIG. 5, and performs processing to store various types of data in the non-volatile memory 5000 or read various types of data stored in the non-volatile memory 5000.

### <Process or Operation>

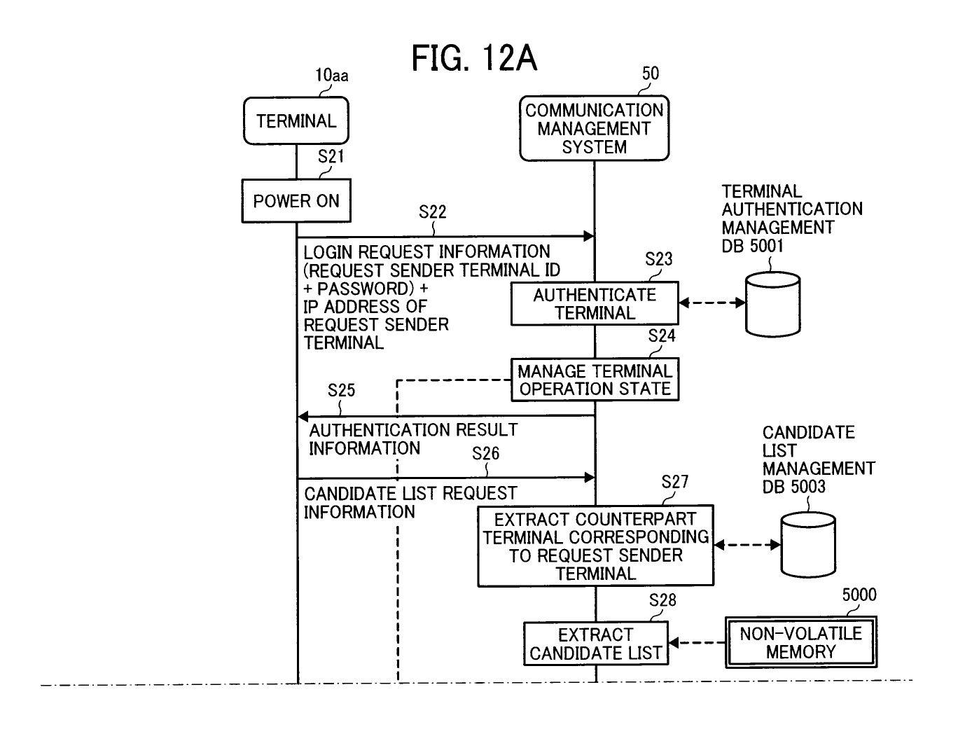

Next, a process or an operation of the embodiment will be described. First, using FIG. 11, the outline of an operation or a process of the embodiment will be described. FIG. 11 is an illustration of transmission/reception state of various types of information in the communication system.

The candidate list management DB 5003 of the management system 50 (an example of a counterpart terminal management system) stores, in association with each other, a terminal ID for identifying a terminal 10 serving as a sender of a request for starting communication (an example of request sender terminal identification information) and a terminal ID for identifying a terminal 10 serving as a candidate counterpart terminal to which the terminal 10 serving as the request sender can give a request for starting communication (an example of counterpart terminal identification information). In the case where the terminal ID of the terminal 10cb (an example of a second communication terminal) participating in a content data session through which content data is transmitted is not stored in the candidate list management DB 5003 in association with the terminal ID of the terminal 10aa (an example of a first communication terminal) participating in this content data session, the data transmitter/receiver 51 transmits information indicating the terminal 10cb to the terminal 10aa. The data transmitter/receiver 51 further receives a request, from the terminal 10aa, for adding the terminal 10cb as a candidate counterpart terminal of the terminal 10aa. In response to the request, the candidate list manager 57 stores the terminal ID of the terminal 10cb as the terminal ID of a candidate counterpart terminal to which the terminal 10aa can give a request for starting communication, to update the candidate list management DB 5003. Accordingly, it is not necessary for the terminals (10aa and 10cb) to ask each other about information necessary for addition as a candidate counterpart terminal, thereby preventing a failure of a request for addition as a candidate counterpart terminal due to excessive burden or misunderstanding of necessary information.

When the request for addition as a candidate counterpart terminal is received, the data transmitter/receiver 51 further receives an approval from the terminal 10cb for this addition request. After acceptance of this approval, the candidate list manager 57 updates the candidate list management DB 5003. Accordingly, addition as a candidate counterpart terminal without permission can be prevented.

When the request for addition as a candidate counterpart terminal is received, the data transmitter/receiver 51 transmits, to the terminal 10aa, information indicating that the addition request has been accepted. Accordingly, the terminal 10aa can detect that the addition request has been accepted, and hence the terminal 10aa can be prevented from giving the same addition request again.

In one example, the data transmitter/receiver 11 of the terminal 10aa receives information indicating that the terminal 10cb is not registered as a candidate counterpart terminal of the terminal 10aa, from the management system 50. Next, the display control 16 of the terminal 10aa displays a key for allowing a user to send a request for adding the terminal 10cb as a candidate counterpart terminal on the display 120aa, on the basis of the transmitted information. Upon acceptance of the addition request by pressing the key, the data transmitter/receiver 11 transmits, to the management system 50, addition request information indicating the addition request. Accordingly, a request for addition as a candidate counterpart terminal can be easily given without having the terminals (10aa and 10ac) ask each other about information necessary for addition as a candidate counterpart terminal.

When the data transmitter/receiver 11 of the terminal 10aa receives the information indicating acceptance of the request for adding the terminal 10ac as a candidate counterpart terminal, from the management system 50, the display control 16 displays on the display 120aa information indicating that the request has been accepted, instead of displaying a key for accepting the above-mentioned request. Accordingly, the user of the terminal 10aa can be prevented from giving the same request again. Further, when the data transmitter/receiver 11 receives information indicating completion of the process of adding a candidate counterpart terminal, from the management system 50, information indicating completion of the adding process is displayed on the display 120aa. Accordingly, the user of the terminal 10aa can see that the terminal 10cb has been added as a candidate counterpart terminal.

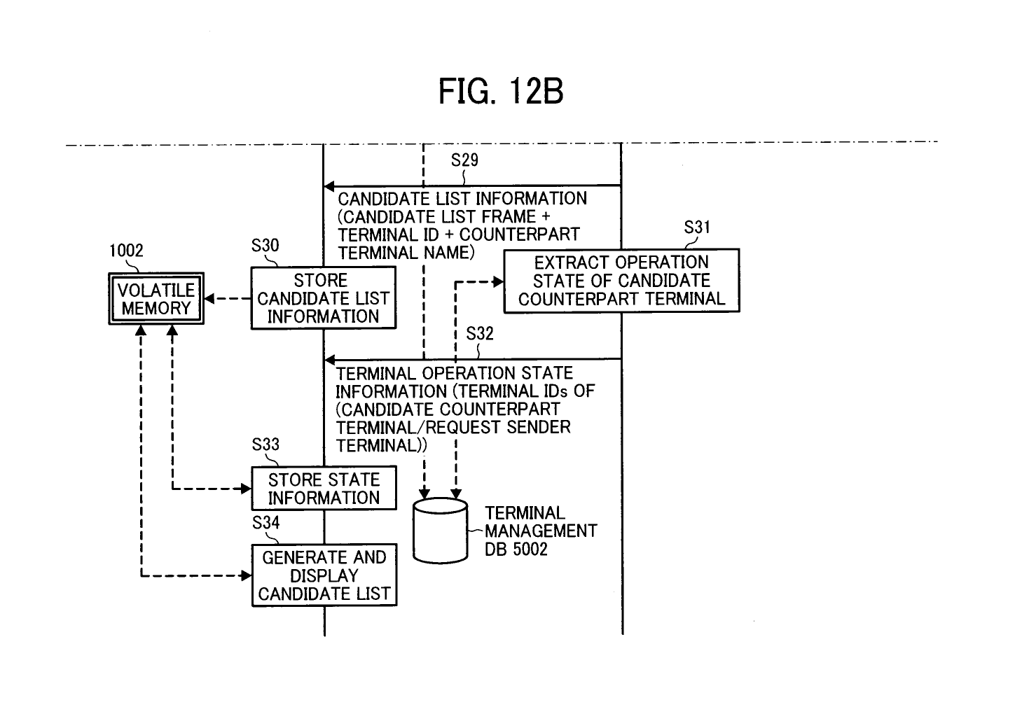

Next, using FIGS. 12 to 19, a process of the embodiment will be described. First, a process of transmitting/receiving each item of management information at a preparation stage before the terminal 10aa participates in a content data session sed will be described using FIGS. 12 and 13. FIG. 12 is a sequence diagram illustrating a process at a preparation stage for starting communication between terminals. FIG. 13 is an illustration of a candidate list. Note that FIG. 12 illustrates a process of transmitting/receiving various items of management information entirely by a management information session sei.

First, when the user of the terminal 10aa turns on the power switch 109 illustrated in FIG. 4, the operation input acceptor 12 illustrated in FIG. 6 accepts the power on operation and turns on the power (step S21). In response to acceptance of the power on operation, the login requester 13 automatically transmits login request information indicating a login request from the data transmitter/receiver 11 to the management system 50 via the communication network 2 (step S22). The login request information includes a terminal ID for identifying the terminal 10aa, which serves as a request sender, and a password. The terminal ID and the password are data that have been read via the data processor 19 from the non-volatile memory 1001 and sent to the data transmitter/receiver 11. In the case of transmitting login request information from the terminal 10aa to the management system 50, the management system 50, which is a receiving side, can detect the IP address of the terminal 10aa, which is a transmitting side.

Next, the terminal authenticator 52 of the management system 50 performs terminal authentication by searching the terminal authentication management DB 5001 (see FIG. 7) of the non-volatile memory 5000 by using the terminal ID and the password included in the login request information received via the data transmitter/receiver 51 as search keys, and determining whether the same terminal ID and the same password are managed in the terminal authentication management DB 5001 (step S23). In the case where the terminal authenticator 52 determines that the login request is a login request from a terminal 10 that has a legitimate use authority since the same terminal ID and the same password are managed, the terminal manager 53 stores, in the terminal management DB 5002 (see FIG. 8), for each record indicated by the terminal ID and terminal name of the terminal 10aa, the operation state, and the IP address of the terminal 10aa in association with one another (step S24). Accordingly, the operation state “online (communication OK)” and the IP address “1.2.1.3” are managed in association with the terminal ID “01aa” in the terminal management table illustrated in FIG. 8.

The data transmitter/receiver 51 of the management system 50 transmits authentication result information indicating an authentication result obtained by the terminal authenticator 52 to the terminal 10aa, which has given the above-mentioned login request, via the communication network 2 (step S25). In the embodiment, the case in which it has been determined by the terminal authenticator 52 that the terminal 10aa is a terminal that has a legitimate use authority will be described as follows.

In response to reception, by the terminal 10aa, of the authentication result information indicating that the request sender terminal is a terminal that has a legitimate use authority, the data transmitter/receiver 11 transmits candidate list request information indicating a request for a candidate list to the management system 50 via the communication network 2 (step S26). Accordingly, the data transmitter/receiver 51 of the management system 50 receives the candidate list request information.

Next, the extractor 54 searches the candidate list management DB 5003 (see FIG. 9) by using the terminal ID “01aa” of the terminal 10aa which has given a login request as a search key, and extracts the terminal ID of each terminal 10 (counterpart terminal) serving as a candidate for a counterpart terminal that can communicate with the terminal 10aa. At the same time, the extractor 54 reads and extracts a counterpart terminal name (terminal name) corresponding to this extracted terminal ID from the terminal management DB 5002 (see FIG. 8) (step S27). Here, the terminal IDs (“01ab”, “01ba”, and “01db”) of counterpart terminals (terminals (10ab, 10ba, and 10db)) corresponding to the terminal ID “01aa” of the terminal 10aa, and terminal names (“AB terminal, Tokyo office, Japan”, “BA terminal, Osaka office, Japan”, and “DB terminal, Washington D.C. office, U.S.”) corresponding thereto are extracted.

Next, the data transmitter/receiver 51 of the management system 50 reads data of a candidate list frame from the non-volatile memory 5000 via the data processor 59 (step S28), and transmits, to the terminal 10aa, “candidate list information (candidate list frame, terminal IDs, and counterpart terminal names)” including this candidate list frame, and the terminal IDs and counterpart terminal names extracted by the extractor 54 (step S29). Accordingly, in the terminal 10aa, the data transmitter/receiver 11 receives the candidate list information, and the data processor 19 stores the candidate list information in the volatile memory 1002 (step S30).

In addition, the extractor 54 of the management system 50 searches the terminal management DB 5002 (see FIG. 8) by using the terminal IDs (“01ab”, “01ba”, and “01db”) of the counterpart terminals, which are extracted by the above-mentioned extractor 54, as search keys, and reads a corresponding operation state for each terminal ID extracted by the above-mentioned extractor 54, thereby obtaining the operation state of each of the counterpart terminals (terminals (10ab, 10ba, and 10db)) (step S31).

Next, the data transmitter/receiver 51 transmits “terminal operation state information” including the terminal ID “01ab” serving as a search key used in step S27 described above and the operation state “offline” of a corresponding counterpart terminal (terminal 10ab) to the terminal 10aa via the communication network 2 (step S32). In addition, as part of step S32, the data transmitter/receiver 51 also separately transmits the remaining “terminal operation state information”, such as “terminal operation state information” including the terminal ID “01ba” and the operation state “online (communication OK)” of a corresponding counterpart terminal (terminal 10ba), to the terminal 10aa.

Next, the data processor 19 of the terminal 10aa sequentially stores the terminal state information, received from the management system 50, in the volatile memory 1002 (step S33). Thus, by receiving the above-described state information of each terminal, the terminal 10aa can obtain the current operation state of each counterpart terminal, such as the terminal 10ab, that can communicate with the terminal 10aa.

Next, the candidate list generator 18 of the terminal 10aa generates a candidate list in which the state of a terminal 10 serving as a candidate counterpart terminal is reflected, on the basis of the candidate list information and the terminal state information stored in the volatile memory 1002, and controls the timing at which the display control 16 displays the candidate list on the display 120 illustrated in FIG. 4 (step S34). Note that, in the candidate list illustrated in FIG. 13, an icon indicating the operation state of each terminal 10 indicates the following from top: “offline”, “online (communication OK)”, and “online (communicating)”.

In contrast, when the user of another terminal 10 turns on the power switch 109 illustrated in FIG. 4, as in step S21 described above, the operation input acceptor 12 illustrated in FIG. 5 accepts the power on operation, and performs processing that is the same as steps S22 to S34 described above, a description of which will be omitted.

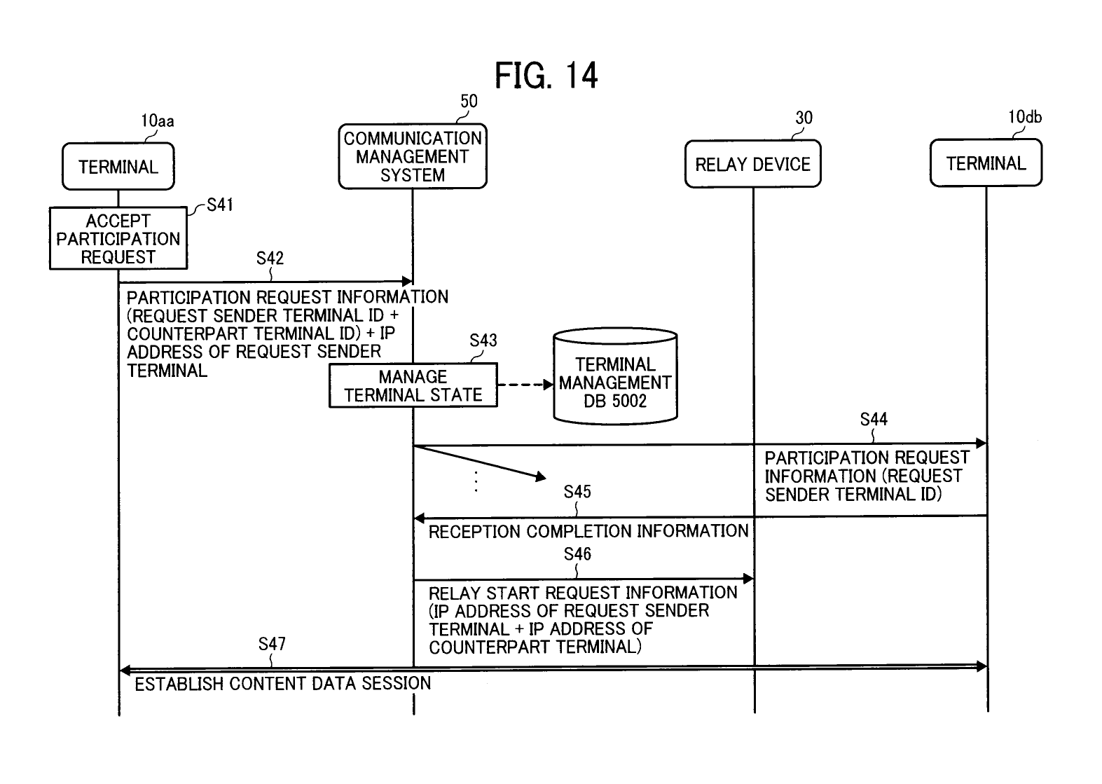

Next, a process for the terminal 10aa to participate in a content data session sed that has been established between the terminal 10db and the terminal 10cb will be described using FIG. 14. FIG. 14 is a sequence diagram illustrating a conference participation operation until a terminal 10 enters a participation state of participating in a videoconference. In the conference participation operation, various types of information are transmitted/received in a management information session sei (see FIG. 2).

First, when the user of the terminal 10aa presses the operation keys 108 to select the terminal 10db, whose operation state is “online (communicating)” (participating in a videoconference), as a communication counterpart terminal, the operation input acceptor 12 accepts a request for participating in the videoconference in which the terminal 10db is participating (step S41).

In response to this request, the data transmitter/receiver 11 of the terminal 10aa transmits, to the management system 50, participation request information that includes the terminal ID “01aa” of the terminal 10aa and the terminal ID “01db” of the terminal 10db and that indicates participation in the videoconference (step S42).

Accordingly, the data transmitter/receiver 51 of the management system 50 receives the participation request information, and can check the IP address “1.2.1.3” of the terminal 10aa, which is the transmission source.

Next, the terminal manager 53 of the management system 50 searches the terminal management DB 5002 (see FIG. 8) by using the terminal ID “01aa” of the terminal 10aa, which is included in the participation request information, as a search key, and sets the operation state of the terminal 10aa, which has given the participation request, to “online (communicating)” (step S43).

Next, the data transmitter/receiver 51 of the management system 50 transmits start request information including the terminal ID “01aa” of the terminal 10aa to the terminal 10db via the communication network 2 (step S44). Accordingly, the terminal 10db can detect from which terminal 10 a request for participating in the videoconference has been given.

Since the operation state of the terminal 10cb in the terminal management DB 5002 illustrated in FIG. 8 is also “online (communicating)”, the data transmitter/receiver 51 of the management system 50 transmits the participation request information including the terminal ID “01aa” of the terminal 10aa to the terminal 10cb via the communication network 2. Accordingly, the terminal 10cb can similarly detect from which terminal 10 a request for participating in the videoconference has been given.

Next, the data transmitter/receiver 11 of the terminal 10db transmits reception completion information indicating that reception of the participation request information has been completed to the management system 50 via the communication network 2 (step S45). Next, the data transmitter/receiver 51 of the management system 50 transmits relay start request information representing a request for starting relaying to the relay devices 30 via the communication network 2 (step S46). The relay start request information includes the IP addresses “1.2.1.3”, “1.3.2.4”, and “1.3.1.4” of the terminal 10aa, the terminal 10db, and the terminal 10cb, respectively.

Accordingly, the relay devices 30 establish a content data session sed for communicating image data and sound data among the terminals 10aa, 10db, and 10cb (step S47). In doing so, the terminal 10aa can participate in the videoconference with the terminal 10db and the terminal 10cb.

Here, image display of a terminal 10 will be described. In the embodiment, the display control 16 corresponds to two display modes, namely, an all-image display mode and an information display mode. Switching between these display modes is performed in response to, for example, operation of the operation keys 108.

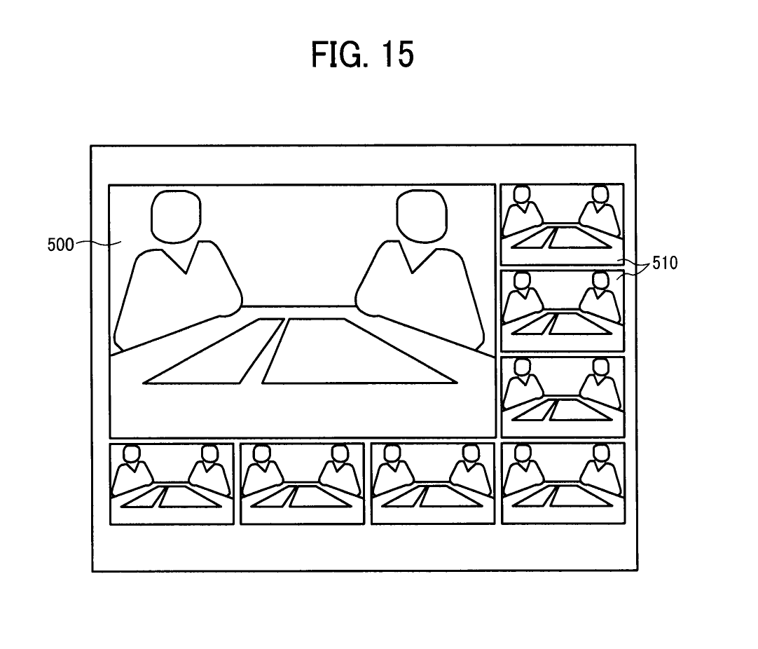

FIG. 15 is an illustration of an example of a display screen in the all-image display mode. As illustrated in FIG. 15, in the all-image display mode, the display control 16 of the terminal 10 displays, on the display 120, all images transmitted from terminals 10 participating in a videoconference.

A first image area 500, which is relatively large, and second image areas 510, which are relatively small, are allocated to the display screen illustrated in FIG. 15. For example, each of the second image areas 510 displays an image represented by image data transmitted from a corresponding one of the terminals 10 participating in a videoconference, and the first image area 500 displays an image represented by image data of a major one of the terminals 10 participating in the videoconference.

For example, the display control 16 identifies, from among the terminals 10 participating in the videoconference, a terminal serving as a transmission source of sound data representing sound in received sound data as a major terminal. Here, sound data representing sound is sound data determined to include a voiced section, which is obtained by subjecting each item of received sound data to sound section detection. Note that technology of the related art can be used to realize sound section detection.

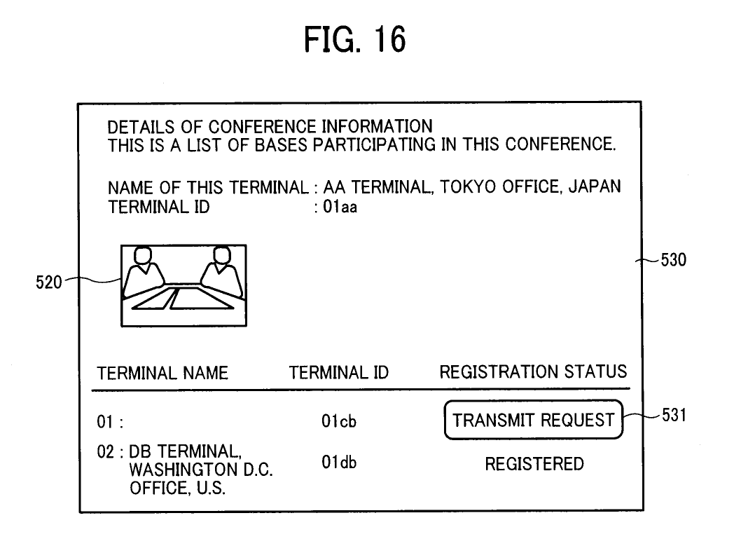

FIG. 16 is an illustration of an example of a display screen in the information display mode. As illustrated in FIG. 16, in the information display mode, the display control 16 of the terminal 10 displays, on the display 120, terminal information at least including the terminal name and terminal ID of each terminal 10 participating in a videoconference (participant terminal).

An image display area 520 for displaying an image and a terminal information display area 530 for displaying terminal information are allocated to the display screen illustrated in FIG. 16. For example, the terminal information display area 530 displays a list of items of terminal information of terminals 10 participating in a videoconference.

Among the items of terminal information displayed in the list, one having no terminal name represents a terminal 10 that is not registered in the candidate list management DB 5003 (see FIG. 9) as a counterpart terminal to which this terminal 10 can give a request for starting communication. For example, in the display screen illustrated in FIG. 16, the terminal name of the terminal 10db is displayed since the terminal 10db is registered as a counterpart terminal of the terminal 10aa in the candidate list management DB 5003; however, the terminal name of the terminal 10cb is not displayed since the terminal 10cb is not registered as a counterpart terminal of the terminal 10aa in the candidate list management DB 5003.

A registration status column corresponding to the terminal 10cb, which is not registered as a counterpart terminal, displays a request transmission key 531. The user of this terminal 10 can give a request for adding the terminal 10cb as a candidate counterpart terminal by pressing the request transmission key 531.

The image display area 520 displays an image representing image data of a major one of the terminals 10 participating in the videoconference. For example, the display control 16 identifies, from among the terminals 10 participating in the videoconference, a terminal serving as a transmission source of sound data representing sound in received sound data as a major terminal. Alternatively, upon acceptance by the operation input acceptor 12 of selection of a single terminal from among the terminals 10 participating in the videoconference in accordance with operation of the operation keys 108 by the user, the display control 16 may identify the selected terminal as a major terminal.

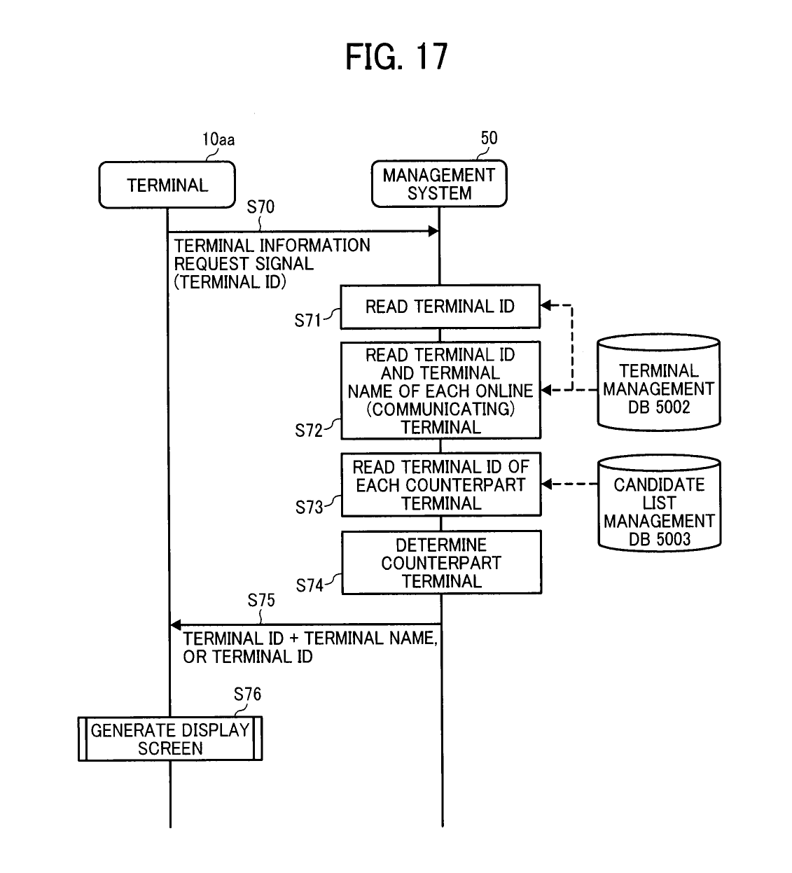

Next, the operation of displaying terminal information in the information display mode will be described in more details. FIG. 17 is a sequence diagram illustrating a terminal information display operation of displaying, when the terminal 10 is switched to the information display mode, terminal information, which is displayed in the terminal information display area 530, in the terminal information display area 530. In the terminal information display operation illustrated in FIG. 17, various types of information are transmitted/received in a management information session sei.

First, the terminal 10aa transmits to the management system 50 a terminal information request signal representing a request for terminal information of each terminal 10 participating in the videoconference (step S70). Accordingly, the management system 50 can detect the IP address of a terminal that is the transmission source of the terminal information request signal. The extractor 54 of the management system 50 searches the terminal management DB 5002 (see FIG. 8) of the memory 5000 by using the IP address of the transmission source of the terminal information request signal as a search key, thereby obtaining the terminal ID of the transmission source (terminal 10aa) of the terminal information request signal (step S71).

Next, the data processor 59 searches the terminal management DB 5002 and reads the terminal ID and terminal name of each terminal 10 whose operation state is “online (communicating)”, that is, each participant terminal participating in the content data session sed (step S72). In the embodiment, the terminal IDs of participant terminals, which are read by the data processor 59, are “01aa”, “01cb”, and “01db”. Note that the operation state of a terminal whose terminal ID is “01aa” has been set to “online (communicating)” in step S43.

Next, the data processor 59 searches the candidate list management DB 5003 (see FIG. 9) of the memory 5000 by using the terminal ID “01aa” of the transmission source of the terminal information request signal, read in step S71, as a search key, thereby reading the terminal ID of each counterpart terminal corresponding to the transmission source of the terminal information request signal (step S73). In the embodiment, the terminal IDs of counterpart terminals, which are read by the data processor 59, are “01ab”, “01ba”, and “01db”.

Next, the counterpart terminal determiner 55 determines whether the terminal ID of each participant terminal, obtained in step S72, is included in the terminal ID of the transmission source of the terminal information request signal or the terminal ID(s) of a counterpart terminal(s), obtained in step S73 (step S74). In the case where it is determined that the terminal ID of each participant terminal is included in the terminal ID of the transmission source of the terminal information request signal or the terminal ID(s) of a counterpart terminal(s), the data transmitter/receiver 51 transmits the terminal ID of the participant terminal and the terminal name of the participant terminal to the terminal 10aa, which is the transmission source of the terminal information request signal. In the case where it is determined that the terminal ID of each participant terminal is not included in the terminal ID of the transmission source of the terminal information request signal or the terminal ID(s) of a counterpart terminal(s), the data transmitter/receiver 51 transmits only the terminal ID of the participant terminal to the terminal 10aa, which is the transmission source of the terminal information request signal (step S75). In the embodiment, the terminal IDs “01aa” and “01db” and the terminal names “AA terminal, Tokyo office, Japan” and “DB terminal, Washington D.C. office, U.S.” of the terminals 10aa and the terminal 10db, and the terminal ID “01cb” of the terminal 10cb are transmitted to the terminal 10aa, which is the transmission source of the terminal information request signal.

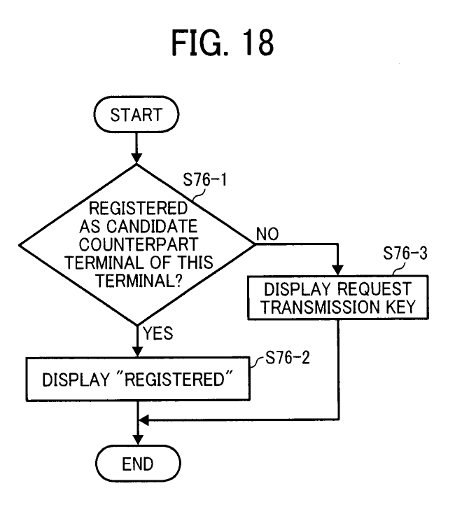

Upon reception of a response to the terminal information request signal from the management system 50, the display control 16 of the terminal 10aa generates a display screen in the information display mode (step S76). The processing in step S76 will be described in detail using FIG. 18. FIG. 18 is a flowchart illustrating a process of generating a display screen.

In the embodiment, in the case where the terminal ID of a participant terminal is managed, in the candidate list management DB 5003 (see FIG. 9), as the terminal ID of a counterpart terminal in association with the terminal ID of this terminal (terminal 10aa) serving as the communication start request sender, the management system 50 transmits the terminal ID and the terminal name to the terminal 10aa (see step S75). In contrast, in the case where the terminal ID of a participant terminal is not managed, in the candidate list management DB 5003, as the terminal ID of a counterpart terminal in association with the terminal ID of this terminal (terminal 10aa) serving as the communication start request sender, the management system 50 transmits only the terminal ID to the terminal 10aa (see step S75).

The display control 16 determines whether the participant terminal is registered as a candidate counterpart terminal of this terminal (terminal 10aa), on the basis of whether the terminal name has been transmitted from the management system 50 (step S76-1). In the case where the participant terminal is registered as a candidate counterpart terminal (YES in step S76-1), the display control 16 displays information indicating that the participant terminal is already registered as a candidate counterpart terminal, in association with the terminal ID of the participant terminal (step S76-2, see FIG. 16). In contrast, in the case where the participant terminal is not registered as a candidate counterpart terminal (NO in step S76-1), the display control 16 displays the request transmission key 531 in association with the terminal ID of the participant terminal (step S76-3, see FIG. 16).

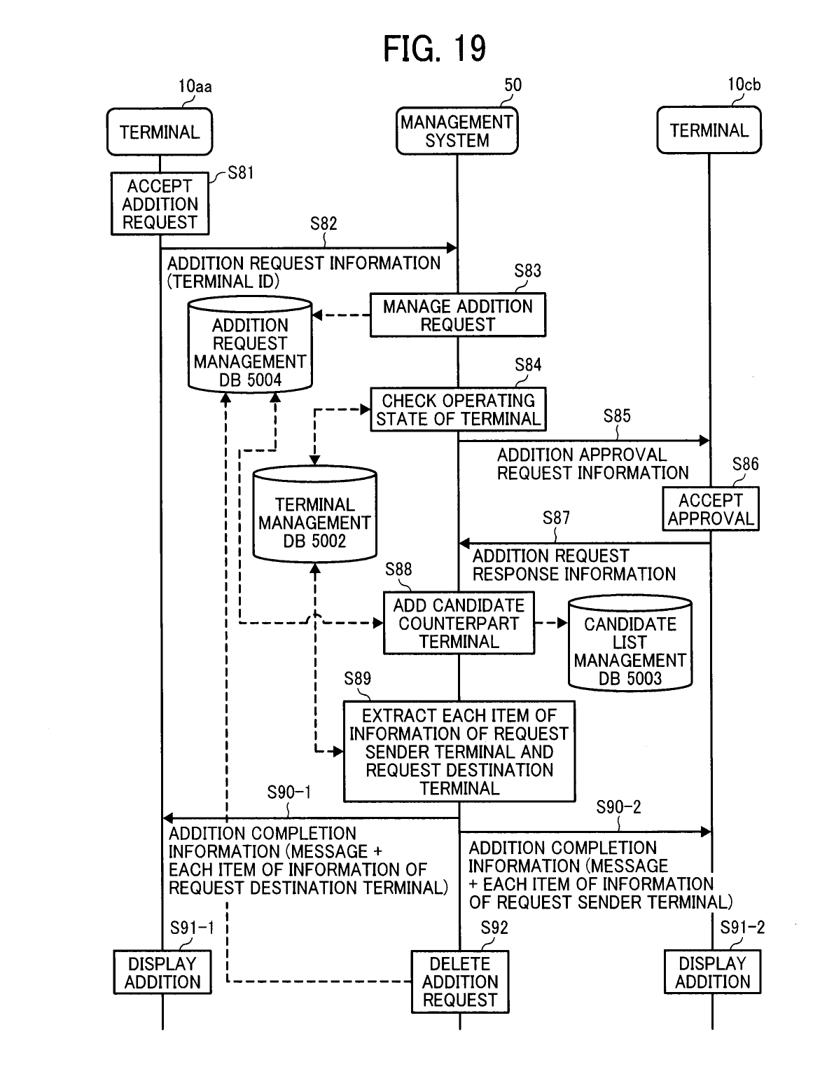

Next, using FIG. 19, a candidate counterpart terminal adding process will be described. The embodiment will discuss the case in which the terminal 10aa gives a request for adding the terminal 10cb, which is participating in a content data session, as a candidate counterpart terminal of this terminal (terminal 10aa). Note that FIG. 19 is a sequence diagram illustrating a candidate counterpart terminal adding process.

First, when the user of the terminal 10aa operates the operation keys 108 on the display screen in the information display mode to press the request transmission key 531 associated with the terminal ID “01cb”, the operation input acceptor 12 accepts a request for adding the terminal 10cb as a candidate counterpart terminal of the terminal 10aa (step S81). Hereinafter, the description will be continuously given while representing the terminal 10aa as an addition request sender terminal, and the terminal 10cb as an addition request destination terminal.

Next, the data transmitter/receiver 11 of the addition request sender terminal (terminal 10aa) transmits addition request information indicating a request for addition as a candidate counterpart terminal to the management system 50 via the communication network 2 (step S82). The addition request information includes the terminal ID “01aa” for identifying the addition request sender terminal (terminal 10aa), and the terminal ID “01cb” for identifying the addition request destination terminal (terminal 10cb). Accordingly, the data transmitter/receiver 51 of the management system 50 receives the addition request information.

Next, in the management system 50, the addition request manager 56 stores and manages the above-received terminal ID “01aa” of the addition request sender terminal in the terminal ID field of the request sender terminal of a new record in the addition request management DB 5004 (see FIG. 10), and additionally stores and manages the terminal ID “01cb” of the addition request destination terminal in the terminal ID field of the request destination field of the above new record (step S83).

Next, the terminal manager 53 searches the terminal management DB 5002 (see FIG. 8) on the basis of the terminal ID “01cb” of the addition request destination terminal, thereby checking a corresponding operation state (step S84). In the case where the terminal manager 53 determines that the operation state is online but the addition request destination terminal has not started communication, the data transmitter/receiver 51 continuously transmits, to the addition request destination terminal (terminal 10cb), addition approval request information indicating a request for a response indicating whether to approve the above-mentioned addition request (step S85). The addition approval request information includes the terminal ID “01aa” of the addition request sender terminal. Accordingly, the data transmitter/receiver 11 of the addition request destination terminal (terminal 10cb) receives the addition approval request information.

Next, on the basis of the operation of the operation keys 108 by the user of the addition request destination terminal (terminal 10cb), the operation input acceptor 12 accepts an input of “approval” for addition as a candidate counterpart terminal (step S86).

Next, the data transmitter/receiver 11 of the addition request destination terminal (terminal 10cb) transmits addition request response information indicating a response indicating whether the addition request has been approved to the management system 50 via the communication network 2 (step S87). Accordingly, the data transmitter/receiver 51 of the management system 50 receives the addition request response information. Here, the case in which the addition request response indicates “approval” will be continuously described.

Next, the candidate list manager 57 additionally registers the terminal ID “01cb” of the addition request destination terminal as the terminal ID of a counterpart terminal corresponding to the terminal ID “01aa” of the request sender terminal in the candidate list management DB 5003 (see FIG. 9) (step S88).

Next, the extractor 54 searches the terminal management DB 5002 (see FIG. 8) on the basis of the terminal ID “01aa” of the addition request sender terminal and the terminal ID “01cb” of the addition request destination terminal, thereby extracting items of corresponding information (counterpart terminal name and operation state) (step S89). Next, the data transmitter/receiver 51 transmits addition completion information to each of the addition request sender terminal (terminal 10aa) and the addition request destination terminal (terminal 10cb) (steps S90-1 and S90-2). Of these items of addition completion information, one transmitted to the addition request sender terminal (terminal 10aa) includes a message indicating that the addition is completed, and items of information (terminal ID, counterpart terminal name, and operation state) of the addition request destination terminal (terminal 10cb). That is, only items of information (terminal ID, counterpart terminal name, and operation state) in the addition request destination terminal (terminal 10cb) portion in the candidate list are transmitted to the addition request sender terminal (terminal 10aa), and the entire candidate list is not transmitted again. In contrast, of these items of addition completion information, one transmitted to the addition request destination terminal (terminal 10cb) includes a message indicating that the addition is completed, and items of information (terminal ID, counterpart terminal name, and operation state) of the addition request sender terminal (terminal 10aa).

In the addition request sender terminal (terminal 10aa) and the addition request destination terminal (terminal 10cb), each display control 16 displays a screen indicating completion on a corresponding one of the displays (120aa and 120cb) (steps S91-1 and S91-2). Note that, on the management system 50 side, when the processing in steps S90-1 and S90-2 ends, the addition request manager 56 deletes a record of the terminal ID “01cb” of the request destination terminal approved in the addition request management DB 5004 (see FIG. 10), and accordingly, the entire process of the request for addition as a candidate counterpart terminal ends (step S92).

### Second Embodiment

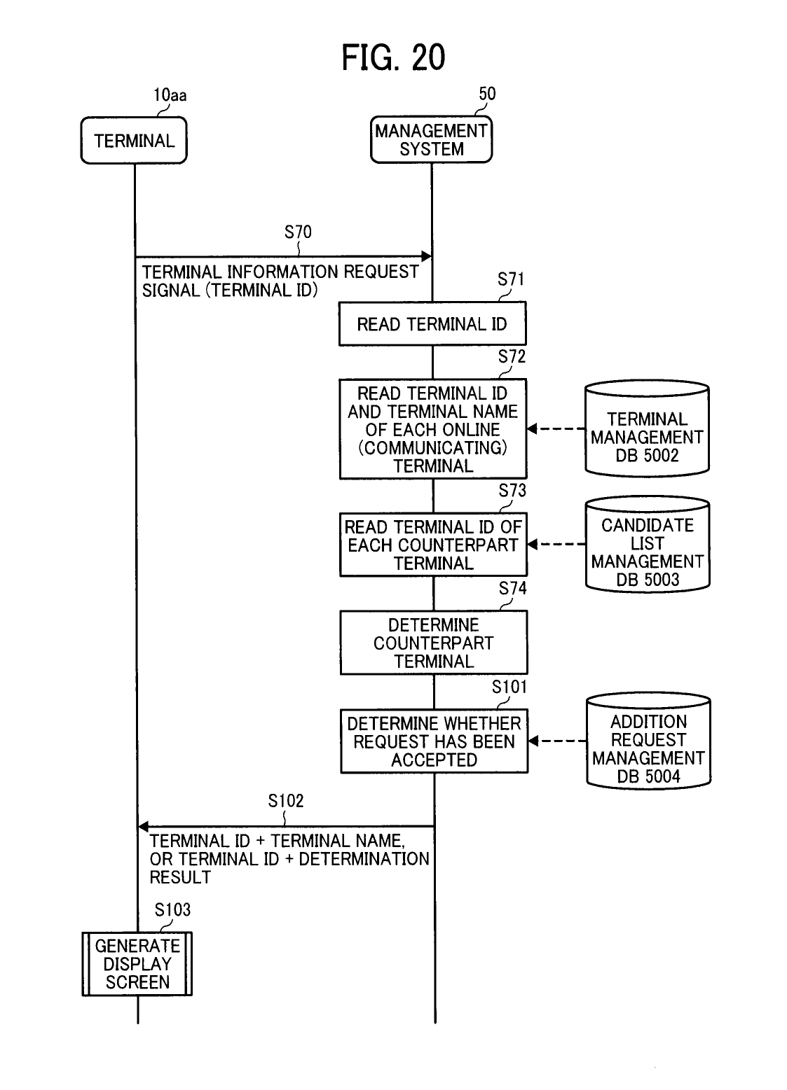

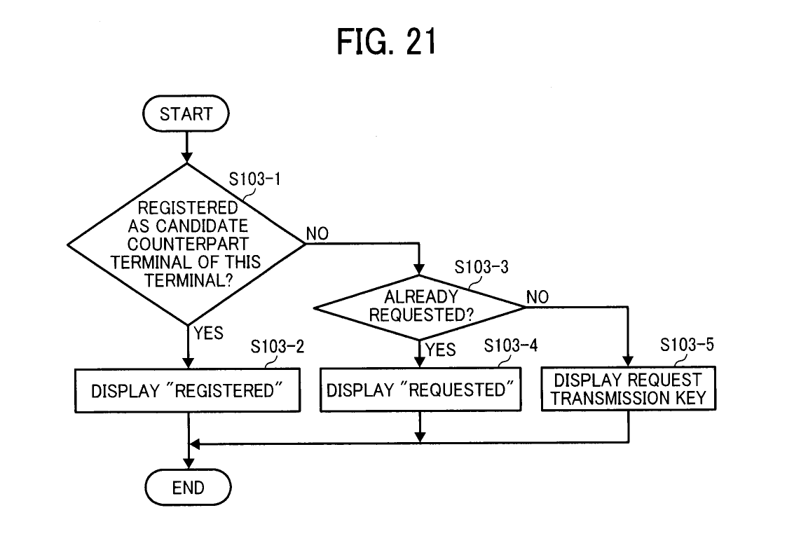

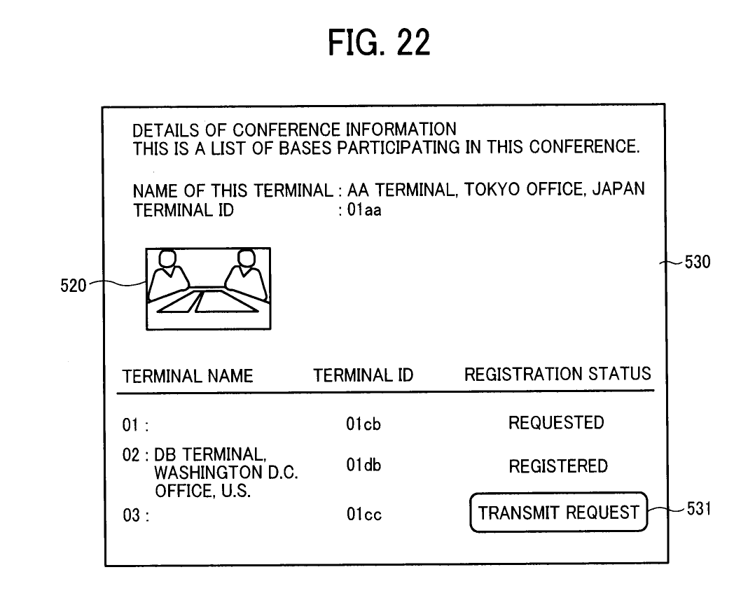

Next, the points of a second embodiment of the present invention that are different from the first embodiment will be described using FIGS. 20 to 22. FIG. 20 is a sequence diagram illustrating a terminal information display operation of a communication system according to the second embodiment. FIG. 21 is a flowchart illustrating a process of generating a display screen. FIG. 22 is an illustration of an example of a display screen in the information display mode.

In a series of processes for generating terminal information, illustrated in FIG. 20, the counterpart terminal determiner 55 determines whether each participant terminal is registered as a counterpart terminal corresponding to the transmission source of a terminal information request signal, as in the first embodiment (step S74). Next, the candidate list manager 57 determines whether a request for adding a participant terminal that is not registered as a counterpart terminal as a candidate counterpart terminal of the transmission source of the terminal information request signal has been accepted (step S101). In this case, the counterpart terminal determiner 55 searches the terminal ID field of the request sender in the addition request management DB 5004 (see FIG. 10) by using the terminal ID of a terminal (terminal 10aa) serving as the transmission source of the terminal information request signal as a search key, thereby extracting the terminal ID of a corresponding request destination. In the case where the terminal ID of a participant terminal that is not registered as a counterpart terminal is included in the extracted terminal ID of the request destination, it is determined that the request for adding that participant terminal as a candidate counterpart terminal has been accepted; if not so, it is determined that the request for adding that participant terminal as a candidate counterpart terminal has not been accepted.

In the case where it is determined that the terminal ID of each participant terminal is included in the terminal ID of the transmission source of the terminal information request signal or the terminal ID(s) of a counterpart terminal(s), the data transmitter/receiver 51 transmits the terminal ID of the participant terminal and the terminal name of the participant terminal to the terminal 10aa, which is the transmission source of the terminal information request signal, as in the first embodiment. In the case where it is determined that the terminal ID of each participant terminal is not included in the terminal ID of the transmission source of the terminal information request signal or the terminal ID(s) of a counterpart terminal(s), the data transmitter/receiver 51 transmits the terminal ID of the participant terminal, and information indicating whether the request has been accepted, which is the determination result in step S101, to the terminal 10aa (step S103).

Upon reception of a response to the terminal information request signal from the management system 50, the display control 16 of the terminal 10aa generates a display screen in the information display mode (step S103). The processing in step S103 will be described in detail using FIG. 21.

As in the first embodiment, the display control 16 determines whether the participant terminal is registered as a candidate counterpart terminal of this terminal (terminal 10aa), on the basis of whether the terminal name has been transmitted from the management system 50 (step S103-1). In the case where the participant terminal is registered as a candidate counterpart terminal (YES in step S103-1), the display control 16 displays information indicating that the participant terminal is already registered as a candidate counterpart terminal, in association with the terminal ID of the participant terminal (step S103-2, see FIG. 22).

In contrast, in the case where the participant terminal is not registered as a candidate counterpart terminal of this terminal (NO in step S103-1), the display control 16 determines whether the request for adding the participant terminal as a candidate counterpart terminal has been accepted, on the basis of the response transmitted from the management system 50 (step S103-3). In the case where it is determined that the request has been accepted (YES in step S103-3), the display control 16 displays information indicating that the participant terminal is already requested to be registered as a candidate counterpart terminal, in association with the terminal ID of the participant terminal (step S103-4, see FIG. 22). In contrast, in the case where it is determined that the request has not been accepted (NO in step S103-3), the display control 16 displays the request transmission key 531 in association with the terminal ID of the participant terminal (step S103-5, see FIG. 22). Accordingly, for a participant terminal that has already been requested to be added as a candidate counterpart terminal, the terminal is prevented from transmitting a request again for adding this participant terminal as a candidate counterpart terminal, such that the same request is prevented from being given again.

According to the above-described embodiments, in the case where a second communication terminal participating in a session for transmitting content data is not registered as a candidate counterpart terminal of a first communication terminal, the counterpart terminal management system notifies the first communication terminal of information indicating the second communication terminal, and accepts a request for adding the second communication terminal as a candidate counterpart terminal. Accordingly, it becomes unnecessary for the communication terminals to ask each other about information necessary for addition as a candidate counterpart terminal. As a result, a failure of a request for addition as a candidate counterpart terminal due to excessive burden or misunderstanding of necessary information can be prevented.

The relay devices 30, the management system 50, and the program providing system 90 in the above-described embodiments may be configured by a single computer or a plurality of computers to which divided portions (functions) are arbitrarily allocated.

In addition, in the case where the program providing system 90 is configured by a single computer, a program transmitted by the program providing system 90 may be separately transmitted in units of a plurality of modules, or may be transmitted in its entirety.

Further, in the case where the program providing system 90 is configured by a plurality of computers, a program may be divided into a plurality of modules, and the modules may be individually transmitted from the respective computers.

In addition, a recording medium such as a compact disc read-only memory (CD-ROM) storing a terminal control program, a relay device program, or a communication management program in the above-described embodiments, the HD 204 storing these programs, and the program providing system 90 including the HD 204 are each used in the case where the terminal control program, relay device program, or communication management program is provided as a program product to users within a certain country or outside that country.

Further, although management is performed while paying attention to the resolution of an image of image data relayed by the relay device 30, which serves as an example of the quality of the image of the image data, the embodiments are not limited to this case, and management may be performed while paying attention to other examples of the quality, such as the depth of the quality of image data, the sampling frequency of sound of sound data, or the bit length of sound of sound data. In addition, sound data may be transmitted/received separately in items of data of three types of resolutions (high resolution, intermediate resolution, and low resolution).

Although the IP address of each terminal 10 is managed in FIG. 8, the embodiments are not limited to this case, and any information for identifying each terminal 10 in the communication network 2, such as the fully qualified domain name (FQDN) of each terminal 10, may be managed. In this case, an IP address corresponding to an FQDN is obtained by a Domain Name System (DNS) server.

In addition, although the case of a videoconference system has been described as an example of the communication system 1 in the above-described embodiments, the embodiments are not limited to this case, and the communication system 1 may be a phone system such as an IP phone system or an Internet phone system.

In addition, the communication system 1 may be a car navigation system. In this case, for example, one of two terminals 10 corresponds to a car navigation apparatus mounted on a car, and the other terminal 10 corresponds to a management terminal or a management server of a management center that manages car navigation, or a car navigation apparatus mounted on another car. In addition, the terminals 10 may be configured by cellular phones in the communication system 1.

In addition, although image data and sound data are described as examples of content data in the above-described embodiments, the content data is not limited to these items of data, and the content data may be touch data. In this case, a feeling obtained by a user's contact at one terminal side is transmitted to the other terminal side.

Further, the content data may be smell data. In this case, a smell at one terminal side is transmitted to the other terminal side. In addition, the content data may be at least one of image data, sound data, touch data, and smell data.

In addition, although the case in which a videoconference is held by the communication system 1 has been described in the above-described embodiments, the embodiments are not limited to this case. The communication system 1 may be used in meetings, general conversation between family members or friends, or one-way presentation of information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In one example, the present invention may reside in A method of managing information regarding one or more counterpart communication terminals for a communication terminal that is participating in a session with at least one counterpart communication terminal, the method including: receiving information indicating that the counterpart communication terminal is not registered as a candidate counterpart terminal for the communication terminal, from a counterpart terminal management system; displaying a user interface component that allows a user to send a request for adding the counterpart communication terminal as a candidate counterpart terminal for the communication terminal; and transmitting the request for adding the counterpart communication terminal as a candidate counterpart terminal for the communication terminal, to the counterpart terminal management system, in response to selection of the user interface component by the user.

In one example, the method further includes: receiving information indicating acceptance of the request for adding from the counterpart terminal management system; and displaying a user interface component indicating that the request for adding is accepted, in alternative to the user interface component allowing the user to send the request for adding.

In one example, the method further includes: receiving information indicating that addition of the communication terminal as a candidate counterpart terminal for the communication terminal is completed, from the counterpart terminal management system, and displaying a user interface component indicating that addition of the communication terminal is completed, in alternative to the user interface component indicating that the request for adding is accepted.

In one example, the displaying displays the user interface component that allows a user to send a request for adding, with identification information for identifying one or more counterpart communication terminals that are participating in the session.

1. A counterpart terminal management system comprising:
a memory that stores, for each one of a plurality of communication terminals capable of requesting to start communication with one or more candidate counterpart terminals, terminal identification information for identifying the communication terminal in association with counterpart terminal identification information for identifying the one or more candidate counterpart terminals;
a transmitter that transmits, to a first communication terminal that is participating in a session with at least a second communication terminal, information indicating that the second communication terminal is not registered as a candidate counterpart terminal for the first communication terminal;
a receiver that receives a request for adding the second communication terminal as a candidate counterpart terminal for the first communication terminal from the first communication terminal, the request for adding being generated based on the information indicating that the second communication terminal is not registered as a candidate counterpart terminal for the first communication terminal; and
processing circuitry that additionally stores counterpart terminal identification information of the second communication terminal in association with terminal identification information of the first communication terminal in response to the request for adding.

2. The counterpart terminal management system of claim 1, wherein
the processing circuitry additionally stores the counterpart terminal identification information of the second communication terminal, in response to receiving an approval to add the second communication terminal as the candidate counterpart terminal of the first communication terminal from the second communication terminal.

3. The counterpart terminal management system of claim 2, wherein
the transmitter further transmits information indicating acceptance of the request for adding to the first communication terminal, when the request for adding is accepted.

4. The counterpart terminal management system of claim 2, wherein
the transmitter further transmits information indicating that addition of the second communication terminal is completed, when the counterpart terminal identification information of the second communication terminal is stored.

5. A communication terminal that is participating in a session with at least a counterpart communication terminal, the communication terminal comprising:
a receiver that receives information indicating that the counterpart communication terminal is not registered as a candidate counterpart terminal for the communication terminal, from a counterpart terminal management system;
a display that displays a user interface component that allows a user to send a request for adding the counterpart communication terminal as a candidate counterpart terminal for the communication terminal; and
a transmitter that transmits the request for adding the counterpart communication terminal as a candidate counterpart terminal for the communication terminal, to the counterpart terminal management system, in response to selection of the user interface component by the user.

6. The communication terminal of claim 5, wherein
the receiver receives information indicating acceptance of the request for adding from the counterpart terminal management system, and
the display displays a user interface component indicating that the request for adding is accepted, in alternative to the user interface component allowing the user to send the request for adding.

7. The communication terminal of claim 6, wherein
the receiver receives information indicating that addition of the communication terminal as a candidate counterpart terminal for the communication terminal is completed, from the counterpart terminal management system, and
the display displays a user interface component indicating that addition of the communication terminal is completed, in alternative to the user interface component indicating that the request for adding is accepted.

8. The communication terminal of claim 5, wherein
the display displays the user interface component that allows a user to send a request for adding, with identification information for identifying one or more counterpart communication terminals that are participating in the session.

9. A communication system, comprising:
the communication terminal of claim 5; and
the counterpart terminal management system configured to communicate with the communication terminal, the counterpart terminal management system including:
a memory that stores, for each one of a plurality of communication terminals capable of requesting to start communication with one or more candidate counterpart terminals, terminal identification information for identifying the communication terminal in association with counterpart terminal identification information for identifying the one or more candidate counterpart terminals; and
a transmitter that transmits, to the communication terminal, information indicating that the counterpart communication terminal is not registered as a candidate counterpart terminal for the communication terminal, based on whether counterpart terminal identification information of the counterpart communication terminal is stored in the memory for the communication terminal.

10. A method of managing information regarding one or more counterpart communication terminals, the method comprising:
storing in a memory, for each one of a plurality of communication terminals capable of requesting to start communication with one or more candidate counterpart terminals, terminal identification information for identifying the communication terminal in association with counterpart terminal identification information for identifying the one or more candidate counterpart terminals;
transmitting, to a first communication terminal that is participating in a session with at least a second communication terminal, information indicating that the second communication terminal is not registered as a candidate counterpart terminal for the first communication terminal;
receiving a request for adding the second communication terminal as a candidate counterpart terminal for the first communication terminal from the first communication terminal, the request for adding being generated based on the information indicating that the second communication terminal is not registered as a candidate counterpart terminal for the first communication terminal; and
storing counterpart terminal identification information of the second communication terminal in association with terminal identification information of the first communication terminal in response to the request for adding.

11. The method of claim 10, further comprising:
receiving an approval to add the second communication terminal as the candidate counterpart terminal of the first communication terminal from the second communication terminal,
wherein the storing stores the counterpart terminal identification information of the second communication terminal, in response to the receiving of an approval.

12. The method of claim 11, further comprising:
transmitting information indicating acceptance of the request for adding to the first communication terminal, when the request for adding is accepted.

13. The method of claim 11, further comprising:
transmitting information indicating that addition of the second communication terminal is completed, when the counterpart terminal identification information of the second communication terminal is stored.
